(19) United States
(12) Patent Application Publication
(10) Pub. No.: US 2025/0100479 A1
(43) Pub. Date: Mar. 27, 2025

(54) VEHICLE CONTROL AND INTERCONNECTION SYSTEM, AND VEHICLE CUSTOMIZATION ENABLED BY SAME

(71) Applicant: Joseph Gormley, Livonia, MI (US)

(72) Inventor: Joseph Gormley, Livonia, MI (US)

(21) Appl. No.: 18/896,757

(22) Filed: Sep. 25, 2024

Related U.S. Application Data
(60) Provisional application No. 63/585,005, filed on Sep. 25, 2023.

(51) Int. Cl. B60R 16/023; G06F 3/0484; G06F 9/451; H04L 67/306

(52) U.S. Cl. CPC B60R 16/023; G06F 3/0484; G06F 9/451; H04L 67/306

(57) ABSTRACT

The use of a hybrid construction for a vehicle control and interconnection system provides a combination of both central and distributed control. This in turn enables a flexible computing architecture that includes an adaptable controller package that in turn interacts with vehicular components, subsystems or systems to make a vehicle responsive to the needs or preferences of a particular user, all while being agnostic to the number or type of vehicular systems or subsystems with which it interacts. In one form, the vehicle control and interconnection system may be used as part of a new vehicle testing platform that allows a prospective buyer to customize and personalize vehicular options prior to placing an order for such new vehicle. The vehicle control and interconnection system may provide a reconfigurable architecture to be used as part of an edge computing-based real-time vehicle control platform.

### CROSS REFERENCE TO RELATED APPLICATIONS

This application claims the benefit of U.S. Provisional Application Ser. No. 63/585,005, filed on Sep. 25, 2023, having the title “VEHICLE CONTROL AND INTERCONNECTION SYSTEM, AND VEHICLE CUSTOMIZATION ENABLED BY SAME”, the disclosure of which is hereby incorporated by reference.

### BACKGROUND

### Field of the Invention

The present disclosure relates generally to a vehicle control and interconnection system and a method of making a vehicle control system by a hybrid manufacturing approach, as well as creating customized interfaces that allow personalized interaction with various vehicular peripheral system operational components.

### Description of the Related Art

Typical motor vehicle systems are set up by the manufacturer with little or no ability to adapt vehicle system operational parameters to the unique physical characteristics, operational preferences and other attributes of individual drivers. Even in the limited number of circumstances where some form of system customization may be possible, it is only through the selection of a few predetermined, fixed settings as decided upon by an original equipment manufacturer (OEM). Such is particularly problematic when an individual is deciding on a particular vehicle for purchase or use, as the amount of time involved in a typical vehicle purchase does not allow for the individual to assess how such customization may best comport with his or her specific needs, preferences or requirements.

### SUMMARY

According to one aspect of the present disclosure, a vehicle control and interconnection system is disclosed. The vehicle control and interconnection system includes system memory, a supervisory processor incorporated into a system in a package (SiP) format and which is communicably coupled to the system memory, a mission function controller communicably coupled to the supervisory processor, a mode function controller communicably coupled to the supervisory processor, a peripheral controller that communicates, responsive to commands initiated by the supervisory processor, via an interface, control messages initiated by the peripheral controller to a corresponding vehicle electronic device and kernel memory that stores code to support at least the supervisory processor and the peripheral controller. The mission function controller and the mode function controller cooperate to receive control information from the supervisory processor and pass modified control information to the peripheral controller.

According to another aspect of the present disclosure, a method of customizing a vehicle user interface to an individual is disclosed. The method includes using a vehicle simulator to engage the individual to perform at least one vehicular operation in the vehicle simulator, where the vehicle simulator is configured to be representative of a particular vehicle being contemplated for purchase by the individual, the vehicle simulator comprising an intrinsic capture unit. In addition, the method includes coordinating the vehicle simulator with a plurality of simulated vehicle electronic devices to cause the vehicle simulator to collect data corresponding to observed behavior of the individual and comprising at least one of sensory data of the individual through the intrinsic capture unit and at least one operational parameter of at least one of the plurality of simulated vehicle electronic devices in response to the at least one vehicular operation that is performed by the individual. The method further includes determining, based on the collected data, a user-optimized setting for at least one of the plurality of simulated vehicle electronic devices, as well as configuring a response profile for the at least one of the plurality of simulated vehicle electronic devices based on the user-optimized setting, the response profile usable to program a customized vehicle user interface of a vehicle control and interconnection system associated with a vehicle.

According to yet further aspects herein, a vehicle control and interconnection system is configured as a system in a package (SiP) device. Here, the vehicle control and interconnection system comprises a substrate with electrical traces formed therein. A first system-on-chip (SoC) device is situated on the substrate and is configured as a kernel. The kernel comprises a supervisory processor that prioritizes a core set of functions, a mission function controller that provides control information that corresponds to customized vehicle operation, a mode function controller that provides dynamic modification of the control information based on at least one determined operating condition of the vehicle, and a peripheral controller cooperative with the supervisory processor to control vehicle electronic devices that are operative to commands by the supervisory processor. In this regard the mission function controller and the mode function controller cooperate to receive control information from the supervisory processor and pass modified control information to the peripheral controller. The vehicle control and interconnection system also comprises a second SoC situated on the substrate, which is configured as a core to be signally cooperative with both the first SoC and substrate through the electrical traces. A plurality of peripheral dies are situated on the substrate, each of the plurality of peripheral dies defining a domain controller that couples the vehicle control and interconnection system to at least one vehicle subsystem. Moreover, an interface establishes signal communication between adjacent peripheral dies and at least one of the first and second SoCs through at least an embedded multi-die interconnect bridge, where the vehicle control and interconnection system establishes signal communication with the at least one vehicle subsystem through at least one of the control information of the mission function controller and the modified control information of the mode function controller.

### BRIEF DESCRIPTION OF THE DRAWINGS

The embodiments set forth in the drawings are illustrative in nature and not intended to limit the subject matter defined by the claims. The following detailed description of the illustrative embodiments can be understood when read in conjunction with the following drawings, where like structure is indicated with like reference numerals and in which:

FIG. 1A depicts a cutaway of a passenger vehicle that may use the vehicle control and interconnection system discussed herein;

FIG. 1B depicts an interior view of the passenger vehicle of FIG. 1A;

FIG. 2 depicts a block diagram of functional connectivity between various components of a vehicle control and interconnection system of a vehicle control apparatus;

FIG. 3A depicts a block diagram of one form of functional interconnectivity of the SiP-based package portion of the vehicle control and interconnection system and various vehicle subsystems according to aspects herein;

FIG. 3B depicts a block diagram of another form of functional interconnectivity of the SiP-based package portion of the vehicle control and interconnection system and various vehicle subsystems according to aspects herein;

FIG. 4 depicts how the SiP-based package portion of the vehicle control and interconnection system is partitioned into a pair of SoC-based supervisor dies that signally connect to various peripheral dies through EMIB bridges;

FIG. 5 depicts a vehicle simulator with an intrinsic capture unit; and

FIG. 6 is a flow chart illustrating a method of performing a vehicle simulation.

### DETAILED DESCRIPTION

The automotive industry has been unable to produce automotive systems that can observe driver preferences and convert them to a more personalized and intuitive driver experience. Moreover, conventional approaches of the automotive industry have been unable to provide such personalization during either pre-purchase or post-purchase situations. Furthermore, vehicle control systems are typically formed of rigid electronic control architectures that do not lend themselves to component upgradability or interoperability, especially for control of vehicular systems that are dynamically adaptable. Thus, attempting to implement such control system or changes thereto is a time-consuming chore that often involves the use of components that are incompatible with one another. This also hampers the ability to implement adaptable control circuitry into a compact, easily manufactured package that promotes increased hardware commonality across numerous vehicular sizes, styles and product lines.

In addition, traditional automobile purchasing promotes an inconsistent approach to having a salesperson accurately match the myriad vehicular product lines, trim offerings, options features or the like with the needs of the car-buying customer. Technically, deducing what a customer's true needs are based on ad hoc criteria that one or both of the salesperson and the customer may not be able to adequately articulate can further compound the difficulty in finding owner-vehicle compatibility. This problem is even more difficult for online shoppers who are bombarded with information, much of which may not be germane to the online shopper's particular needs. Yet further, online shoppers often struggle to understand the complicated options that accompany vehicle packages that may or may not be compatible with the online shopper's needs.

In this regard, aspects of the present disclosure provide a technical solution in the form of a vehicle control and interconnection system that provides a flexible vehicle computing architecture. In an example form, sensory data is collected and acted upon by the vehicle control and interconnection system (examples of which are discussed herein) to provide driver-specific customization and/or optimization of various vehicular systems. Aspects herein also provide a centralized architecture for the control of such vehicular systems. Additionally, aspects herein provide a flexible architecture for a vehicle control and interconnection system that employs a novel hybrid manufacturing approach that in turn provides attributes of both centralized and distributed control over various vehicular systems.

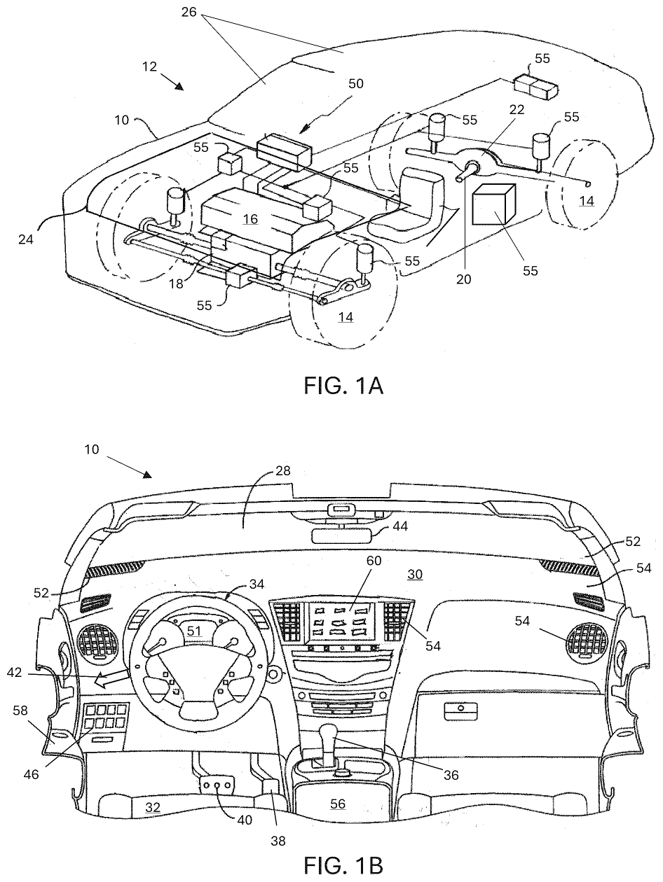

Referring first to FIG. 1A, a cutaway schematic view of a vehicle 10 is shown. Although presently shown as a passenger car, vehicle 10 may assume any form, including a truck, a sport utility vehicle (SUV), an emergency vehicle, a motorcycle, a bus, a construction vehicle, watercraft, aircraft, or the like. For example, a construction vehicle may include an earthmover, a grader, a bulldozer, a backhoe, a crane, a loader, a compactor, a conveyor, an excavator and a dump truck, among others. The vehicle 10 may include a chassis 12 with a plurality of wheels 14. Chassis 12 may either be of body-on-frame or unibody construction, and both configurations are deemed to be within the scope of the present disclosure. A motive power unit 16 such as a conventional internal combustion engine (ICE), battery pack, fuel cell stack or a hybrid combination of one or more of the above may be situated in or on the chassis 12 (such as in an engine compartment, trunk, along an underneath lengthwise direction or the like) to provide propulsive power to the vehicle 10. A transmission 18 is coupled to the motive power unit 16 such that together they form a drivetrain through which a torque may be applied to some or all of the wheels 14, such as through one or more shafts 20 and a differential 22 such that together the wheels 14, one or more shafts 20 and differential 22 cooperate with drivetrain to form a powertrain. As shown, the motive power unit 16 is situated underneath a hood 24 that is placed at the fore end of vehicle 10. Exterior body components 26 are formed on top of or as part of the chassis 12, and may include one or more of fairings, bumpers, fascia, door panels, roof, trunk lid, grilles, trim, headlights, taillights, a windshield, side and rear windows, mirrors or related parts.

Schematically, FIG. 1A illustrates a vehicle control and interconnection system 50 that communicates control messages to corresponding vehicle electronic devices 55, e.g., domain controllers, sensors, electronic components, input/output devices such as human-machine interfaces, etc., as will be described in greater detail herein.

For the sake of clarity of discussion herein, other vehicular systems (or subsystems, depending the layers of component granularity and the distinction of which will be apparent from the context) can be provided, as is standard in the vehicle industry. Such additional vehicular systems may be made cooperative with a vehicle control and interconnection system that is described in more detail as follows, and that the presence or absence of such other systems may depend on the particular configuration of vehicle 10. Accordingly, it will be understood that all such other systems are deemed to be within the scope of the present disclosure. It will be further understood that any combination of systems (whether discussed in detail or not) may be made signally cooperative with the vehicle control and interconnection system 50 through vehicle electronic devices such as individual system controllers, and that such controllers may be distributed through the vehicle 10 in a manner that optimizes there interoperability. Thus, by way of brief introduction, the vehicle control and interconnection system 50 can modify the control of vehicle electronic device to provide features such as adjustable fuel delivery and handling dynamics, customizable operator and/or passenger comforts and communication operations, as well as monitoring and control of augmented safety apparatus features, emission control, dynamic driving experiences, etc.

Referring next to FIG. 1B, an interior view of the vehicle 10 of FIG. 1A is shown, illustrating aspects of an example passenger compartment 28 and a front dash 30. As will be described in greater detail herein, a vehicle control and interconnection system (see vehicle control and interconnection system 50, FIG. 1A) allows portions of the vehicle 10 through its various vehicle electronic devices (e.g., vehicle electronic devices 55, FIG. 1A) to be tailored to be modified and/or augmented, e.g., to modify a vehicle from standard factory settings, to satisfy the need of a particular driver and/or passenger (also referred to herein as user, operator or the like), etc., through its flexible computing architecture. More particularly, as will be described more fully, the vehicle control and interconnection system links and controls aspects of a corresponding vehicle in a hybrid central/distributed architecture, such that various normally dissociated and/or communicably disconnected systems can function in cooperation in a customized and cohesive manner.

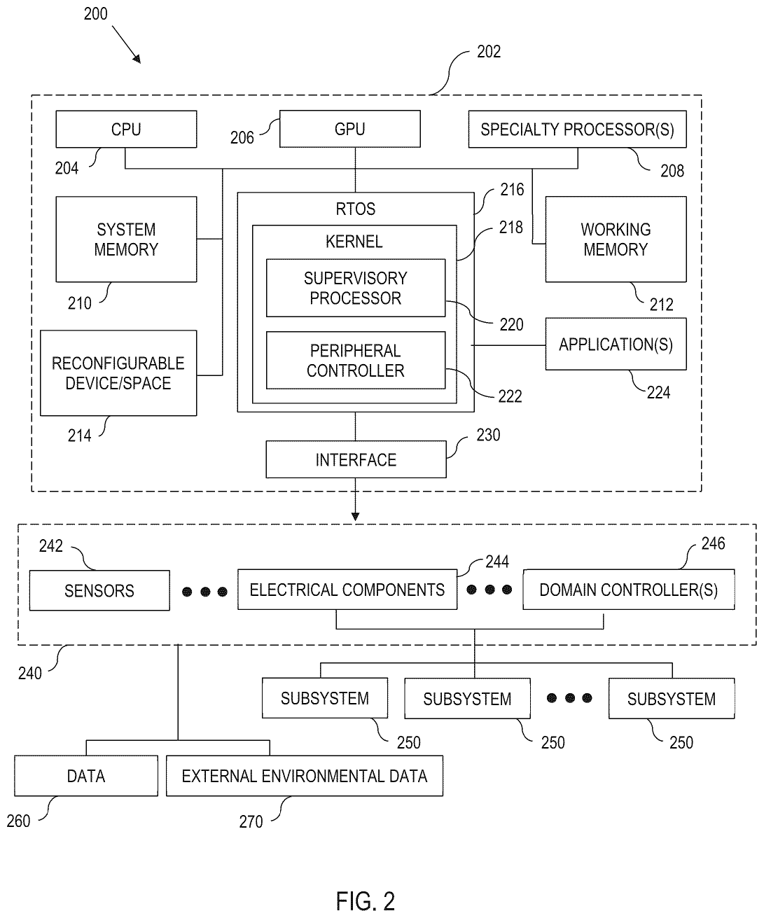

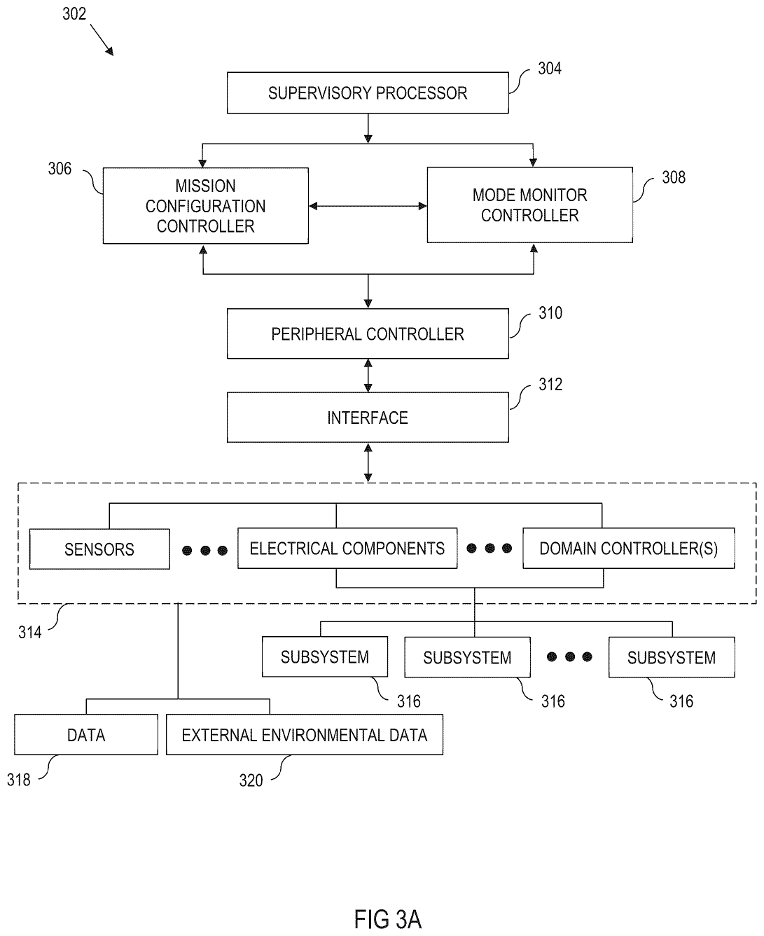

As illustrated, the passenger compartment 28 includes a seat 32 from which a driver may operate the vehicle 10 and control one or more of the vehicle systems or subsystems. As will be discussed in conjunction with FIGS. 2 and 3, examples of the vehicular systems or subsystems may include those for propulsion, vehicle dynamics, communications, security, creature comfort, diagnostics and monitoring, electrical, coolant or the like. Moreover, the functionality of some of the systems may overlap such that, in at least some forms of operation, these overlapping systems cooperate with one another in order to bring about an intended result. Thus, guidance apparatus (which may include, among other things, one or more of a steering wheel 34, gear shift indicator 36, accelerator pedal 38, brake pedal 40, turn signal 42, mirror 44, adjustment switches 46 or the like) may make up one or more systems or subsystems that are used in cooperation with the wheels (14, FIG. 1A), motive power unit (16, FIG. 1A), transmission (18, FIG. 1A) and other systems or subsystems (FIG. 1A) to control movement of the vehicle 10.

Likewise, various human-machine interfaces (HMIs) can be provided within the passenger compartment 28. Examples of such HMIs include, but are not limited to, dashboard display(s) 51 (e.g., a speedometer, tachometer, fuel gauge, information panel, error panel, etc.), speakers 52, ventilation ducts 54, center console controls 56, armrest controls 58, a graphical user interface 60 (GUI) such as what may control an infotainment system, etc. These HMIs may also include some of the aforementioned devices such as the steering wheel 34, gear shift indicator 36, accelerator pedal 38, brake pedal 40, turn signal 42, mirror 44 and adjustment switches 46, as well touchscreens that are associated with an infotainment system, and additionally other sensory devices help to keep the driver or passengers apprised of conditions inside and outside of the vehicle 10.

In some example implementations, one or more HMIs may provide structural and/or functional overlap. For instance, disparate locations may be used for various switches and/or control functions, input controls and other means of inputting requests into or receiving outputs from various vehicle systems. For instance, controls on the steering wheel 34 may also control an infotainment system, messages on an infotainment system may also appear in the dashboard display(s) 51, etc., where such overlap will be dependent upon the amount of integration attendant to their modularity.

As yet another example, one HMI may function as a primary input/output device, such as those associated with popular infotainment screens that frequently occupy a large and central region within the front dash 30 and which may also include or be made operationally cooperative with an external communications system that may in turn include one or more of a modem, radio, cellular, Wi-Fi, combinations thereof, or the like for the receipt and transmission of one or more short-, medium- or long-range wireless signals using known protocols. It will be appreciated that the vehicle control and interconnection system disclosed herein, helps to optimize one or more HMIs to better accommodate variability in an individual user's driving habits, desired creature comforts, preferred vehicular options or the like.

### Example Vehicle Control and Interconnection System Interfacing Vehicle Electronics

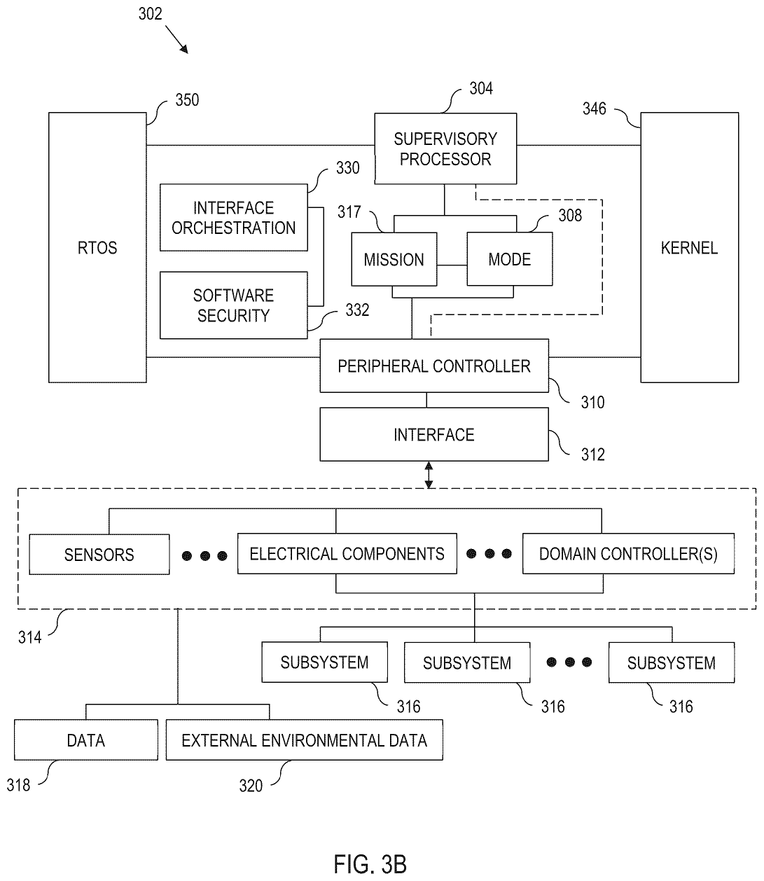

Referring next to FIG. 2, a block diagram 200 depicts a block diagram of certain features of a vehicle architecture that includes a vehicle control and interconnection system 202. FIG. 2 also illustrates communicative coupling of the vehicle control and interconnection system 202 to various vehicle electronics, described more fully below. The illustrated vehicle control and interconnection system 202 can implement for instance, the vehicle control and interconnection system 50 illustrated in the vehicle of FIG. 1A, FIG. 1B. In an example implementation, one or more aspects of the vehicle control and interconnection system 202 may be structured as a tiled computing architecture that will be discussed in more detail in conjunction with FIG. 4. Regardless, the vehicle control and interconnection system 202 provides the corresponding vehicle with a flexible, integrated control system that provides features and capabilities not available to conventional vehicles.

As illustrated, the vehicle control and interconnection system 202 includes at least one central processing unit (CPU) 204. The vehicle control and interconnection system 202 can also include one or more additional processors, such as an optional graphics processing unit (GPU) 206 and/or one or more optional specialty processors 208, e.g., one or more application specific integrated circuits (ASIC), one or more field programmable gate arrays (FPGA), a complex instruction set microprocessor (CISC), a reduced instruction set computer (RISC) processor, a digital signal processing chip (DSP), Super Harvard Architecture Single-Chip computers (SHARC), etc.

The vehicle control and interconnection system 202 further includes memory, such as system memory 210, optional working memory 212, and/or other memory usable by the architecture, such as a reconfigurable device space 214, which can include any combination of memory space (software), programmable logic space (hardware), etc.

The control and interconnection system 202 includes a real-time operating system 216. Although schematically illustrated as a functional block, the real-time operating system 216 can be implemented in the memory, e.g., loaded in a protected area of system memory 210. At the core of the real-time operating system 216, is a kernel 218.

The kernel 218 implements control over actions of the vehicle control and interconnection system 202 by facilitating interactions between hardware and software components of the corresponding vehicle that communicate with the vehicle control and interconnection system 202. In this regard, the kernel 218 is illustrated as having a supervisory processor 220 and a peripheral controller 222. Other features are described in greater detail with reference to subsequent FIGURES herein.

The vehicle control and interconnection system 202 can also include optional application(s) 224. The applications 224 can reside in any one or more of the available memory devices, e.g., system memory 210, working memory 212, reconfigurable device space 214, etc. The applications 224 can be used to provide user interfaces, interfaces for programming customizations, selecting preferences, or otherwise providing user interactions with the vehicle control and interconnection system 202.

The vehicle control and interconnection system 202 has signal connectivity and related interconnection with various vehicular systems or subsystems, i.e., vehicle electronic devices. In this regard, the vehicle control and interconnection system 202 is schematically illustrated as having an interface 230. Connectivity between the various vehicle electronic devices may be through one or more networks/vehicle busses that are specifically configured for vehicular applications, such as a controller area network (CAN) bus or other communication bus as known in the vehicle industry.

In one non-limiting form, the various vehicle electronic devices 240 that interact with the vehicle control and interconnection system 202 may include—among others—a propulsion system, a steering system, a vehicular dynamics system, an electric power system, a body system, a coolant system, a communications system, a creature comfort system, a fuel system, a security system, a safety system, an infotainment system as well as other systems. Furthermore, some of these systems may interact with or control various subsystems, such as how the propulsion system may include a drivetrain that includes a transmission and engine subsystem. It will be further understood that certain vehicular systems may have overlapping functionality or dependencies (for example, between the steering system and the dynamics system), as well as having interactions with one another either directly or indirectly. Yet further, the present description of systems versus subsystems, as well as which systems may be grouped with or otherwise associated with a particular component as being part of one or another system or subsystem, is a matter of semantics, and that in any given vehicular configuration, the cooperation between them is within the purview of the designer, overall system integrator or the like. All variants of these and other systems are deemed to be within the scope of the present disclosure.

More particularly, as illustrated with regard to FIG. 2, the vehicle control and interconnection system 202 utilizes the interface 230 to interact with numerous vehicle electronic devices 240. In this regard the interface 230 acts as a gateway between the vehicle control and interconnection system 202 and native vehicle systems.

By way of illustration and not by way of limitation, the vehicle electronic devices 240 can optionally include vehicle sensors 242, (e.g., temperature sensors, rain sensors, tire pressure sensors, and any other sensors on the vehicle),

The vehicle electronic devices 240 can also optionally include vehicle electronical components 244 (e.g., third-party peripheral devices such as radios, radar detectors, etc., factory infotainment systems, vehicle processors, or other vehicle devices capable of communicating electronically, etc.).

Yet further, the vehicle electronic devices 240 can also optionally include domain controllers 246. By way of non-limiting example, domain controllers 250 may include a vehicular dynamics system controller, an engine controller, a steering controller, a climate control system controller, a seat position controller, an accelerator controller, a brake controller, a turn signal indicator controller, an infotainment system controller, a security system controller and combinations thereof.

The vehicle electronic devices 240 can optionally communicate with vehicle subsystems 250, i.e., native vehicle components controlled by the associated native vehicle domain controllers 246. In addition, the vehicle electronic devices 240 can collect data 260, e.g., sensor data, etc. Additionally, the vehicle electronic devices 240 can collect external environment data 270, e.g., via sensors, wireless communication with external sources such as via Wi-Fi/the Internet, via environmental scanning (e.g., from LiDAR or other vehicle technology, etc.).

As such, information available to the vehicle control and interconnection system 202 can originate from any form of information, including customer data, third-party peripheral information, external data, internal data, dynamic data, or the like.

Various domains correspond to vehicle electronic devices 240 that in one form, can be dedicated to a particular one of the vehicle subsystems 250 and which may receive instructions from, as well as report data back to, the vehicle control and interconnection system 202. In one form, each domain controller may be directing more than one vehicle subsystem 250 in a peer-to-peer exchange arrangement.

The vehicle control and interconnection system 202 can be located anywhere in the corresponding vehicle, e.g., behind the dashboard, although it will be appreciated that other locations within the vehicle, such as within the aforementioned engine compartment or trunk may also be utilized, depending upon packaging and related vehicular system integration factors. Input into the vehicle control and interconnection system 202, e.g., to interact with one or more applications 224, may through a touchscreen, keypad, voice command, camera or other known means, including those associated with so-called smart features that allow user input to be conveyed from such devices and carried over a network to the vehicle control and interconnection system 202.

As previously noted (and which will be described in more detail in conjunction with FIG. 4), a tiled architecture of the vehicle control and interconnection system 202 allows both SiP and SoC attributes. In one form, the SiP is configured with memory, e.g., system memory 210 and/or working memory 212 that stores authorized and validated vehicle software applications 224, that can interface with the vehicle, user, and optionally carry out customized vehicle functions. In one form, an optional eFPGA (specialty processors 208) and the reconfigurable device space 214 are configured so that at least one of the SoCs that are described in more detail in conjunction with FIG. 4 may be configured as a programmable SoC (PSoC) where algorithms directed to vehicle control may be divided for parallel processing between the supervisory processor 220, the GUI 60 and the eFPGA.

The eFPGA allows hardware processing functionality to be programmed and modified to add new hardware processing capability, thereby further enhancing overall flexibility and modularity to the tiled architectures of the vehicle control and interconnection system 202. In one form, reconfigurable device space 214 available on one or both of the SoCs—in conjunction with the eFPGA (specialty processors 208) permits at least some amount of upgradability of the vehicle control and interconnection system 202, such that changes to the vehicle (including one or both of new and aftermarket models) would be possible. Details associated with the reconfigurable device space 214 and its cooperation with the eFPGA may be found in U.S. Pat. No. 7,590,768 (entitled CONTROL AND INTERCONNECTION SYSTEM), U.S. Pat. No. 7,596,636 (entitled SYSTEMS AND METHODS FOR IMPLEMENTING A VEHICLE CONTROL AND INTERCONNECTION SYSTEM) and U.S. Pat. No. 8,694,328 (entitled VEHICLE CUSTOMIZATION AND PERSONALIZATION ACTIVITIES) all of which are owned by the Assignee of the present disclosure and the entirety of which are incorporated herein by reference.

### Example Vehicle Control and Interconnection System

Referring next to FIG. 3A and FIG. 3B, block diagrams illustrate examples of a vehicle control and interconnection system 302. Any aspects described with reference to FIG. 3A or FIG. 3B can be substituted or combined with any combination of features of the control and interconnection system 202 (FIG. 2) and/or the vehicle control and interconnection system 50 (FIG. 1A). Moreover, between FIG. 3A and FIG. 3B, like structure is implemented with like reference numbers unless otherwise noted.

FIG. 3A and FIG. 3B provide two example forms of the functional interconnectivity of the vehicle control and interconnection system and various vehicle subsystems (which may further include vehicle peripheral system operational components). Although the blocks represented in FIGS. 3A and 3B (as well as some of those of FIG. 2) are depicted as discrete, individual and tangible structural components such as processors, memory or the like, many of them may alternatively be software virtualizations based on the functions that they perform. In some embodiments, such virtualizations may be embodied as part of integrated or distributed hardware architectures consistent with one or more of the SoC and SiP approaches disclosed herein. It will be understood that the kernel may perform some or all of the virtualization in its capacity as a hypervisor.

Referring with particularity to the embodiment of FIG. 3A, a supervisory processor 304 (e.g., analogous to the supervisory processor 220, FIG. 2) interacts with both a mission function controller 306 and a mode monitor controller 308 to carry out vehicle control functions, examples of which are described herein. For instance, the mission function controller 306 and the mode monitor controller 308 can be implemented in a kernel layer of a real-time operating system (e.g., analogous to that described with reference to FIG. 2). Notably, as illustrated by the arrows, the supervisory processor 304 may issue commands but does not respond to commands. In some implementations, the supervisory processor 304 may receive data, but not commands.

The mission configuration controller 306 and the mode monitor controller 308 communicate with a peripheral controller 310 (e.g., analogous to the peripheral controller 222, FIG. 2). The peripheral controller 310 communicates via the interface 312 (e.g., analogous to the interface 230, FIG. 2), with vehicle electronic devices 314 (e.g., analogous to the vehicle electronic devices 240, FIG. 2). Moreover, the vehicle electronic devices 314 can communicate with the vehicle subsystems 316 (e.g., analogous to vehicle subsystems 250, FIG. 2), and the vehicle electronic devices 314 can read, generate, or otherwise interact with data 318 (analogous to data 260, FIG. 2) and/or external environmental data 320 (analogous to the external environmental data 270). In this regard, description of analogous elements between FIG. 2 and FIG. 3A can be freely interchangeable and/or combinable in any combination.

In example implementations, the mission configuration controller 304 carries out commands (e.g., augments, carries out, modifies, or otherwise enables commands) issued by the supervisory processor 304 in response to a particular mission associated with driving a corresponding vehicle. For instance, the mission configuration control 306 can be utilized to oversee integrated operation or otherwise coordinate performance characteristics of various vehicle systems, e.g., based upon entered preference data (e.g., data directed to the mission configuration control 306 through an I/O device within the vehicle, detected/sensed preference data, combinations thereof, etc. As an example, an identified “mission” may comprise an anticipated application of the vehicle, such as off-roading, towing, use as a work vehicle, vacation/travel vehicle, commuter vehicle, etc.

The mode monitor controller 308 modifies commands issued by the supervisory processor 304 based upon detecting a particular operating mode or triggering event, i.e., performance characteristics. The mode monitor controller 308 may also be further operatively configured to dynamically modify the control information based upon at least one determined operating condition, e.g., based upon at least one of sensed operational conditions, inferred operational conditions, sensed environmental conditions and inferred environmental conditions.

For example, a mode may change via one or more operator entered parameters such as “off-road” or “sport-handling” selections. In one form, the mode monitor controller 308 may provide or adjust additional parameters, e.g., related to data being fed back from the operating environment of the vehicle, such as through sensed environmental conditions, inferred environmental conditions, sensed operating conditions, inferred operating conditions and operator preference inputs or other forms of operational or sensed data 318. By way of example, a mode of operation may change in response to an operator-entered parameter adjustment of one or more of the vehicle subsystems, interfaces, etc.

Thus, the mission configuration controller 306 and the mode monitor controller 308 may cooperate to dynamically modify configuration data during vehicle operation, e.g., based upon at least one of sensed environmental conditions, inferred environmental conditions, sensed operating conditions, inferred operating conditions and operator preference data.

Moreover, feedback from various sensors that are either dedicated to a particular component, system or subsystem or that form a part of a specialized sensor network, can provide valuable diagnostic mode-based information to the mode monitor controller 308, that when fed back to the vehicle control and interconnection system, helps to adjust various performance characteristics in order to best meet the needs of the particular mission.

In an example implementation, the supervisory processor 304 interacts with both the mission function controller 306 and the mode monitor controller 308 in order to prioritize a core set of functions as well as a prime set of functions that will be discussed in more detail in conjunction with FIG. 4. As another example, the supervisory processor 304 may prioritize an auxiliary set of functions after the prime set of functions. In one form, the auxiliary set of functions includes one or more of a telematic function and a video capture system.

The mission configuration controller 306 and the mode monitor controller 308 may cooperate to dynamically modify configuration data of the vehicle in a real-time manner, such as during operation. Likewise, the mission configuration controller 306 and the mode monitor controller 308 cooperate to receive control information from the supervisory processor 304 and pass modified control information to the peripheral controller 310.

In an example implementation, during operation, when the supervisory processor 304 call outs any one or more of the vehicle electronic devices 314 (as peripherals that in one form may be made up of docked or connected devices as identified in one or more of the foregoing U.S. Pat. Nos. 7,590,768, 7,596,636, 8,694,328 and 9,7747,626), it does so in a way that allows the exchange of data, instructions or the like (e.g., via the interface 312) to be performed without regard to the physical layer of the underlying hardware.

### Example Vehicle Control and Interconnection System

Referring next to FIG. 3B, a block diagram illustrate an example of a vehicle control and interconnection system 302 that is analogous to the vehicle control and interconnection system 302 of FIG. 3A, and includes additional features to that described in FIG. 3A. In this regard, all aspects of FIG. 3A are incorporated into FIG. 3B, unless otherwise noted.

Notably, analogous to FIG. 3A, a supervisory processor 304 interacts with both a mission function controller 306 and a mode monitor controller 308 to carry out vehicle control functions, examples of which are described herein. For instance, the mission function controller 306 and the mode monitor controller 308 can be implemented in a kernel layer of a real-time operating system (e.g., analogous to that described with reference to FIG. 2).

The mission configuration controller 306 and the mode monitor controller 308 communicate with a peripheral controller 310. The peripheral controller 310 communicates via the interface 312, with vehicle electronic devices 314. Moreover, the vehicle electronic devices 314 can communicate with the vehicle subsystems 316, and the vehicle electronic devices 314 can read, generate, or otherwise interact with data 318 and/or external environmental data 320. In this regard, description of analogous elements between FIG. 2, FIG. 3A, and FIG. 3B can be freely interchangeable and/or combinable in any combination.

In addition to the features analogous to FIG. 3A, the vehicle control and interconnection system 302 in FIG. 3B includes an interface orchestration component 330 that cooperates with a software security component 332 to act upon the sensed, inferred or otherwise known data, e.g., data 318, such as to determine whether an updated configuration is operating within a predefined range, rules or other suitable operating characteristic. If the interface orchestration component 330 does not approve the configuration, feedback is supplied to one or both of the mission configuration controller 306 and the mode monitor controller 308 to either bring the data into compliance, abort the operation, or take other appropriate action. If the interface orchestration component 330 authorizes the configuration, then the supervisory processor 304 implements various supervisory tasks, such as by providing control information to the mission configuration controller 306 in order to coordinate performance characteristics of potentially unrelated vehicle electronic devices 314 based upon at least one determined operating condition (for example, a new configuration, setting or the like).

In one form, the mission configuration controller 306 interacts with the interface orchestration component 330 so that an operator or other may interact with the mission configuration controller 306. In one form, such interaction is through a display such as the GUI, or other form of user interface. In one form, the operator may select one or more customizable modes of operation of the vehicle.

The software security component 332 ensures that operational conditions do not permit the vehicle to operate in such a manner as to cause harm, such as the rick of injury or damage to the vehicle or any of its vehicle subsystems.

In one form, the mission configuration controller 306 interacts with the interface orchestration component 330 to carry out a select the customized operation of the vehicle. Likewise, the interface orchestration component 330 may interact with the software security component 332 to verify and/or validate the selected customized operation and corresponding control information to ensure proper operation of the vehicle according to predefined security rules.

As previously noted, functional implementation of the various blocks may be virtualized. For example, one or more of the supervisory processor 304, mission configuration controller 306, mode monitor controller 308, peripheral controller 310, interface orchestration component 330, software security component 332, or combinations thereof, may run in a kernel 340 of a real-time operating system 350.

For instance, in an example implementation, cooperation of one or both of the mission configuration controller 306 and the mode monitor controller 308 is virtualized such that a hypervisor verifies compatibility with the vehicle electronic devices 314. In other words, the mission configuration controller 306 and the mode monitor controller 308 may be virtualized processors controlled by a hypervisor that certifies the mission configuration controller 306 and the mode monitor controller 308 as verified compatible with the vehicle electronic devices 314.

This in turn allows the supervisory processor 304 to prioritize functions in the form of a core set of functions, a prime set of functions and an auxiliary set of functions. In one form, the mission configuration controller 306 passes down commands from the supervisory processor 304 and that are relevant to one or more of the prime set of functions that correspond to various ones of the domain controllers, some of which will be discussed in conjunction with FIG. 4 and its various peripheral dies.

In one form, a SiP-based architecture of the vehicle control and interconnection system 302 is configured such that control only flows from the supervisory processor 304 to the vehicle electronic devices 314 whereas vehicle electronic device data can flow to the supervisory processor 304.

By prioritizing the prime set of functions, the mission configuration controller 306 carries out commands from the supervisory processor 304 to a relevant one or more of the prime set of functions, where the prime set of functions includes for example: an energy function controller that controls a vehicle energy domain subsystem of the vehicle, a propulsion function controller that controls a vehicle propulsion domain subsystem of the vehicle, a dynamics function controller that controls a vehicle dynamics domain subsystem of the vehicle, a personalization function controller that controls a vehicle personalization domain subsystem of the vehicle, a security function controller that controls a vehicle security domain subsystem of the vehicle or a communication function controller that controls a vehicle communication domain subsystem of the vehicle.

As previously noted, the supervisory processor 304 prioritizes core, prime and auxiliary sets of functions. In one form, the auxiliary set of functions may be run after the prime set of functions. Such auxiliary set of functions may be numerous, and include operations directed to informing the operator of the status of the vehicle; such operations may include those for telematic or informatics, as well as a video capture system for display of processing and conveying to the operator certain movements or other areas of interest relating to the operation of the vehicle.

In one form, the peripheral controller 310 may be configured as an applications programming interface (API) or other interface in addition to or in lieu of a gateway, hardware components or the like.

Consistent with the various forms and functionalities of the control architecture, as illustrated, the supervisory processor 304 can pass down in a one-way manner, instructions to the mission configuration controller 306, mode monitor controller 308, or both. Both the mission configuration controller 306 and the mode function controller 306 can pass commands, data, or other information back and forth to each other. However, commands are not passed back up to the supervisory processor 304. In an optional form, the communication between the supervisory processor 304 and the peripheral controller 310 may be two-way. Likewise, the peripheral controller 310 can share information, including data, commands or the like in a two-way manner with the mission configuration controller 306, the mode function controller 306, or both. Furthermore, a gateway may form part of the peripheral controller 310 to share information in a two-way manner with the vehicle electronic devices 314. In this regard, personal token customization is enabled by structural elements with the supervisory processor 304 that—through contributed functionality—moves control down the hierarchy with specific peer-to-peer directions for the mission configuration controller 306 and the mode function controller 306.

The aspects of the control architecture discussed herein provide one or both of the mission configuration controller 306 and the mode monitor controller 308 in such a way to make the system sensitive to changing conditions in the environment that are either sensed, inferred or selected via bilaterally processing messages through the hierarchy of the vehicle control and interconnection system 302.

In an optional form, operating conditions used by the supervisory processor 304 provide control information to the peripheral controller 310 that in turn, provide instructions to vehicle electronic devices 314. In example implementations, this layer of modular control permits one or both of the supervisory processor 304 and the peripheral controller 310 to operate in a manner that is agnostic to a particular vehicle configuration, as well as that of the various domain controllers and their respective vehicle subsystems. Thus, a vehicle control apparatus (in general) and the vehicle control and interconnection system 302 (in particular) may control hierarchical communications networks with overall vehicle system configurations capable of being customized and responsive to both operator selections and environmental conditions, which may be both sensed or inferred.

In one form, information related to responses may be based upon operator preference data, as well as the feedback of data 318 during operation of the vehicle. Modes may change as a result of sensed operational conditions, inferred operational conditions, sensed environmental conditions or inferred environmental conditions. As previously discussed, while the supervisory processor 304 and the peripheral controller 310 operate to provide hierarchical control, other forms of cooperation and communication may be made to take place in a peer-to-peer manner, such as between the various vehicle electronic devices 314.

With reference to FIG. 1A, FIG. 1B, FIG. 2, FIG. 3A and FIG. 3B, a vehicle control and interconnection system that electrically and communicably couples to native vehicle electronics, comprises system memory and a supervisory processor, which may be incorporated into a system in a package (SiP) format, and which is communicably coupled to the system memory. The vehicle control and interconnection system also comprises a mission function controller communicably coupled to the supervisory processor, and a mode function controller communicably coupled to the supervisory processor. Also, the vehicle control and interconnection system includes a peripheral controller that communicates, responsive to commands initiated by the supervisory processor, via an interface, control messages initiated by the peripheral controller to a corresponding vehicle electronic device. Moreover, kernel memory stores code to support at least the supervisory processor and the peripheral controller. Here, the mission function controller and the mode function controller cooperate to receive control information from the supervisory processor and pass modified control information to the peripheral controller.

In an example implementation, the mission function controller interacts with an interface orchestration that provides a graphical user interface that enables a vehicle operator to interact with the mission function controller to select the customized operation of the vehicle and a software security process that verifies and validates the operator selected customized operation and corresponding control information to ensure proper operation of the vehicle according to predefined security rules.

In another example implementation, the mission function controller and the mode function controller are virtualized processors controlled by a hypervisor that certifies the mission function controller and the mode function controller as verified compatible with the vehicle electronic devices.

In some implementations, the supervisory processor prioritizes a prime set of functions such that the mission function controller carries out commands from the supervisory processor to a relevant one or more of the prime set of functions. For instance, the prime set of functions can comprise an energy function controller that controls a vehicle energy domain subsystem of the vehicle, a propulsion function controller that controls a vehicle propulsion domain subsystem of the vehicle, a dynamics function controller that controls a vehicle dynamics domain subsystem of the vehicle, a personalization function controller that controls a vehicle personalization domain subsystem of the vehicle, a security function controller that controls a vehicle security domain subsystem of the vehicle, a communication function controller that controls a vehicle communication domain subsystem of the vehicle, or combinations thereof.

In some implementations, the supervisory processor prioritizes, after the prime set of functions, an auxiliary set of functions, the auxiliary set comprising at least one of a telematic function and a video capture system.

In some implementations, the SiP further comprises working memory that stores authorized and validated vehicle software applications that carry out customized vehicle applications. As another example, the SiP can further comprise a neural network that learns over time, vehicle specific optimizations that alter set points passed down by the supervisory processor, based upon data collected by sensors on the vehicle and based upon feedback provided by the mode function controller. In yet another example, the SiP can include a field programmable gate array configured such that hardware processing functionality can be programmed and modified to add new hardware processing capability.

As still another example, the SiP can be configured such that control commands can flow down from the supervisory processor to the peripheral controller, no commands can flow from the peripheral controller up to the supervisory processor, and data collected through the peripheral controller can flow up to the supervisory processor.

In some implementations, the supervisory processor can issue commands based upon data collected by at least one vehicle sensor, the collected data processed by at least one of the mission function controller or the mode function controller. For instance, the collected data can be derived from an external source via at least one of a telematics unit or Wi-Fi on the vehicle.

Referring next to FIG. 4, a notional SiP-based construction (or tiled architecture) of the vehicle control apparatus 400 (in general) and the vehicle control and interconnection system 402 (in particular) is shown. The vehicle control and interconnection system 402 is made up of a pair of cooperating SOCs operating within a kernel-based module SiP. Rather than having a single overarching vehicular controller that regulates the operation of various individual peripheral subsystems directly, the module is partitioned into a pair of SoC-based supervisor dies made up of a centributed (a portmanteau of “central control” and “distributed control”) supervisor 406 and a processor supervisor 408.

Significantly, this SiP-based tiled architecture permits reconfigurability that is not possible with direct control over the various vehicle subsystems 250 that are identified in general in FIGS. 2, 3A and 3B and described elsewhere. Significantly, the author of the present disclosure has determined that such an architecture is particularly beneficial in modern vehicles 10 because of the dynamic properties that the vehicular systems may exhibit, such as through changes in operating parameters due to software, firmware or hardware upgrades (some of which may be performed over-the-air (OTA), as well as customization-based operation such as through driver or purchaser preferences. An example of this OTA approach to conveying information to the vehicle 10 may be found in U.S. Pat. No. 9,747,626 (entitled VEHICLE CUSTOMIZATION AND PERSONALIZATION ACTIVITIES) which is owned by the Assignee of the present disclosure and the entirety of which is incorporated herein by reference. In this way, the vehicle control and interconnection system 202, 302, 402 and its SoC-based supervisor die approach does not have a specific standard about the type of circuitry it contains. In one form, the present design of the vehicle control and interconnection system 202, 302, 402 provides an open software framework such that third-party software vendors may customize or otherwise reconfigure their associated vehicular systems or subsystems in order to promote case of interoperability of such system or subsystem with the vehicle control and interconnection system 202, 302, 402.

In one form, a software development kit (SDK) or related approach such as the aforementioned API 230 may be used in order to enable software developers (including those associated with one or more of the aforementioned OEMs or third-party (including Tier 1) suppliers) to create machine code that can be converted into executable programs that are used to interface with the various parts of the vehicle control and interconnection system 202, 302, 402 so that information (including real-time) pertaining to a driver, operator or other user may be exchanged not only within the vehicle control and interconnection system 202, 302, 402 but between it and various subsystems or systems within the vehicle 10 as well. In a similar manner, the HMIs discussed herein may be used to facilitate low-code/no-code approaches to producing application software for use by the vehicle control and interconnection system 202, 302, 402. In such case, the hybrid architecture depicted by the SoC-SiP approach discussed herein—in conjunction with the GUI 60 (FIG. 1B) or related HMI may form the basis for a model-driven design such as a low-code development platform (LCDP) or related end-user computing environment. In this way, lower costs and development complexity associated with the setup, training, deployment and maintenance of the vehicle control and interconnection system 202, 302, 402 as well as systems based on the same may be realized.

By way of example, an LCDP based on the vehicle control and interconnection system 202, 302, 402 as described herein may play a significant role at the OEM level to ensure that accurate, relevant and objective knowledge related to the design of vehicle 10 and its systems and subsystems such that the subjectivity associated with asymmetric information (such as that possessed by the software designer, retail salesperson or the like) relative to the end user is avoided.

Within the present disclosure, it will be understood that both the contributed supervisor 406 and the processor supervisor 408 may encapsulate one or more processors (in the form of CPUs, microcontrollers, digital signal processors (DSPs) or the like), as well as optional accelerators and other ancillary hardware such as one or more of memory, input/output, graphical processor units, radios, co-processors or the like. By integrating the processors, memory, interface control, clocking, graphics, buses, peripheral controllers (such as for USB or other storage), input/output, radio-frequency (RF) networking components (such as those based on WiFi, Bluetooth or the like), neural network circuitry or the like onto a single chip, the SoCs of the contributed supervisor 406 and the processor supervisor 408 reduce area and increase speed, reduce power consumption as part of an embedded system.

The memory may include random access memory (RAM), read only memory (ROM) or other known forms of non-transitory computer-readable medium, including those that are embodied on hard disk drives, removable media storage devices such as flash drives, erasable programmable read-only memory (EPROM), DVD-ROM drives, CD-ROM drives or the like that are signally connected to each other through a network, bus or the like. In one form, the one or more processors execute computer readable code (also called machine code that forms computer-readable instructions) that may be stored in the memory and that instructs the one or more processors to implement the computer-implemented processes discussed herein.

In a like manner, although the supervisory processor 220, 304 is shown in FIGS. 2 and 3A-B, respectively as being a separate component from the peripheral controller 222, it will be appreciated that their structure may be combined into a single component or device. Functionally, the supervisory processor 220, 304 (FIGS. 2-3B) may split its time as both (i) an overall supervisor (as described herein) of the vehicle control and interconnection system 202 where it directs the contributed course of actions and (ii) a supervisor of one or more of the other processors of FIG. 2. As such, the supervisory processor 220, 304 (FIGS. 2-3B) may be understood conceptually as being a single entity or a pair of separate, discrete entities both of which are within the scope of the present disclosure.

Computer-program code for carrying out operations for aspects of the present disclosure may be written in any combination of one or more programming languages. The program code may be executed either entirely on the vehicle control and interconnection system 202, 302, 402 or partly thereon, the latter through some form of distributed architecture, including one or more other controllers. In one form, such code may include an RTOS that is capable of loading (that is to say, booting up) directly. In another form, information that is used as part of a mission or mode contains reconfigurable data, such as driver or prospective customer personal data, as well as passenger data and data associated with preferred or other particular system/subsystem settings. By way of example, the eFPGA will be understood to be implemented within a controller consistent with its embedded nature, as are one or more FPGAs into chips such as the contributed supervisor 406, the processor supervisor 408 or other data center and communication ICs.

In one form, the eFPGA enables one or both of the SoC-based supervisor dies to act as a flexible logic unit that allows the hardware- and software-programmable logic units of the vehicle control and interconnection system 202, 302, 402 to be reconfigured to meet situation-dependent end-user needs, such as for algorithmic operations, vehicle subsystem data acquisition and management or the like. Moreover, computational latency (which is particularly significant in vehicular safety and security systems such as supplemental restraint systems, anti-theft devices or the like) is reduced due at least in part to operational proximity of the computational activities. Furthermore, the use of eFPGAs helps to extend the useful life of an IC in that hardware upgrades may be incorporated without having to repurpose the entire chip architecture. In one form, the eFPGA uses certain configurations with which to be programmed to a particular state, such as through one or both of the mission and mode that make up a core set of functions. This in turn allows it to perform logical operations for supporting a particular protocol, such as through the arrangement and connecting of logic gates, lookup tables and other associated equipment. In one form, virtualization may be enabled through the previously-discussed hypervisor, such as to promote at least some of the kernel-based operations disclosed herein.

Within the present disclosure, the contributed supervisor 406 can form a part of the kernel 218, 346 (FIGS. 2-3B) such that in one form substantially complete control over the vehicle control apparatus 100 is enabled. Additional functional capability is provided by the various central and peripheral processors, CPUs, microprocessors, ASICs, GPUs, DSPs, RTOS, custom application blocks, FPGAs, memory, design and configuration libraries, communications subsystems (some of which may include 5G or other related modems) and reconfigurable device space 214. In one particular form, the kernel 218, 346 (FIGS. 2-3B) is made up of the centributed supervisor 406, RTOS, the processor supervisor 408 and an eFPGA. In this manner, the kernel 218 (FIG. 2) is part of a core that acts as a lynchpin for the various peripheral systems and associated components of vehicle 10. As can be seen, the kernel 218, 346 (FIGS. 2-3B) provides the pair of supervisors 406, 408 in a partitioned manner so that upgrades or related changes in one may be performed without impacting the other. Relatedly, the architecture shown allows for a clearly defined hierarchy of system operations such that the core has overall control over interfaces, applications, subsystems and domains as part of the vehicle control and interconnection system 202, 302, 402. In this manner, the kernel 218, 346 (FIGS. 2-3B) operates to correlate software control (as provided by the one or more forms of application software) with eh various processors, memory and vehicular system components or systems. Moreover, in configurations where large amounts of data (such as data 260, 318 (FIGS. 2-3B)) are being collected (such as image capture and identification, syntax structure for large language models (LLMs) or the like), additional specialty-purpose processors such as the aforementioned GPUs or other accelerators may also provide some or all of the additional functional capability

Numerous peripheral dies 420 that in one form correspond to various system interfaces are also shown. In one form, these peripheral dies 420 may function as domain controllers and may include a mission die 420A, a mode die 420B, an energy die 420C, a communications die 420D, a vehicle dynamics die 420E, a propulsion/powertrain die 420F, a security die 420G and a personalization die 420H. Although eight of these peripheral dies 420A-H are presently shown, it will be appreciated that they may be greater or fewer in number, depending on the system needs. It will be appreciated that the individual ones of these peripheral dies 420 may or may not precisely align with the aforementioned vehicular systems, and that such alignment or lack thereof is merely a reflection of how an individual system designer or overall vehicle integrator bookkeeps, accounts for or otherwise assigns operational responsibility over a particular system or subsystem. These dies provide tiled space for the placement of both the mission configuration control 306 (FIGS. 3A-B) and the mode monitor controller 308, as well as for the various domain controllers 426 such as an energy function controller 426C, a communication function controller 426D, a dynamics function controller 426E, a propulsion function controller 426F, a security function controller 426G and a personalization function controller 426H. As noted elsewhere, peer-to-peer communication between these various domain controllers 426 may be made to take place.

Each of these peripheral dies 420A-H, as well as the core dies of the contributed supervisor 406 and the processor supervisor 408, are electrically connected to their immediately adjacent neighbor through embedded multi-die interconnect bridge (EMIB) bridges 430. The author of the present disclosure has determined that the high-density package assembly that is made possible through integrated circuit (IC) miniaturization may benefit from the dense interconnections of the EMIB bridges 430. Relatedly, the SiP architecture and related high aspect ratio packaging may benefit from the increased density that EMIB bridges 430 as a way to provide three-dimensional layer-to-layer connectivity.

Although not shown, it will be appreciated that an elevation dimension of a SiP-based package of the vehicle control and interconnection system 402 improves the volumetric efficiency with which the vehicle control and interconnection system 202, 302, 402 may be integrated within the vehicle 10 (FIGS. 1A-B). By the construction depicted in these two figures, at least this portion of the vehicle control and interconnection system 202, 302, 402 may be understood as having a hybrid architecture with both intralayer SoCs and interlayer SiP-based construction. Thus, as depicted in FIG. 4, contributed control may be thought of as a supervisor 406 that corresponds to the agnostic way to perform mission and mode control along with interface orchestration and software security (that may be attributed to the kernel 218, 346 (FIGS. 2-3B)), while distributed control is carried out at the domain level under a core 408 that corresponds to the agnostic way to act as go-between of the kernel 218, 346 (FIGS. 2-3B) and the various vehicle subsystems 250, 316 (FIGS. 2-3B).

This hybrid SoC-SiP construction enables the formation of a modular system with related flexible computing architectural forms. In one form, this modularity includes having a circuit board forms the structural and electrical connectivity foundation with which to integrate the SiP-based package of the vehicle control and interconnection system 402 into a larger vehicular system. An array of solder bumps (also referred to as solder balls or package balls) are situated on top of the circuit board and operate to promote numerous paths for signal connectivity while keeping the use of physical space to a minimum.

Along with the EMIB bridges 430, the various ICs such as the eFPGA, centributed supervisor 406, processor supervisor 408 or the like may be stacked vertically onto a substrate and underneath a package lid in order to form a three-dimensional connection space. By such construction, the SiP-based package of the vehicle control and interconnection system 402 defines a functional package that integrates multiple functional chips, including processors and memory, into a single package. Thus, whereas the SoCs of the contributed supervisor 406 and processor supervisor 408 are formed under a single chip (and often using the same photolithographic or related process), the stacking nature of the SiP-based package of the vehicle control and interconnection system 402 may take advantage of vertical or horizontal fabrication methods in order to stack MEMs, optical devices, RF devices or related devices into wafer-level packaging. Numerous packaging technologies, including wire bonding, flip chip, chip stacking, substrate cavity, substrate integrated RF devices, embedded resistors, capacitors, inductors, TSVs or the like may be used in order to produce the SiP-based package of the vehicle control and interconnection system 402. Such an approach is particularly beneficial in situations where the size of SoCs reaches their lower manufacturability limit, especially for the high-vibratory, mass-produced requirements of automotive end-use applications.

Regardless of whether or not the SiP/SOC hybrid architecture of FIG. 4 is employed, the vehicle control and interconnection system 202, 302, 402 may be understood conceptually as establishing control and data flow both internally within itself, as well as for the various subsystems and systems that make up vehicle 10. In one form, this conceptual model provides a three-tiered relationship. In the topmost tier, the overall control may be provided, such as through the contributed supervisor 406. Also within the topmost tier, data and control flow between the mission, mode, interface orchestration and software security. Many or all of the flows extend in both directions such that an initial flow of information (for example, an instruction) may be followed with a response based on feedback from a system or subsystem controller (such as the domain controller 246, 314 (FIGS. 2-3B). By way of example, the mission determines an overarching immediate objective. Thus, if the vehicle 10 (FIG. 1) is a truck with towing capacity, the mission may be what system or subsystem settings need to be adjusted (and to what degree) to tow a trailer up a hill. Likewise, if the vehicle 10 (FIG. 1) is a passenger car being powered by an electric motor, the mission may be what system or subsystem settings need to be adjusted (and to what degree) to reach the nearest recharging station. Moreover, the mode may correspond to system or subsystem feedback or related input indicating what a subsystem or system is capable of providing in order to achieve the mission. The interface orchestration may be used to decide which modes of which vehicular systems or subsystems to adjust in order to promote cooperation with one another. The software security may act to prevent the interface orchestration from permitting the vehicle 10 (FIG. 1) to make an unintended or intended incorrect maneuver or setting change that could otherwise jeopardize the health or safety of the driver or passengers, as well as prevent certain operations that would cause damage to one or more of the systems or subsystems. For example, the software security would prohibit the transmission from shifting to a gear lower or higher than that which is acceptable from an engine-matching map. Within the intermediate tier, the domain controllers (which may be embodied as the peripheral dies 420) respond to control signals generated within the topmost tier by communicating among themselves as part of a distributed control (which is shown embodied as the processor supervisor 408). In one form, the individual domain controllers 246, 314 (FIGS. 2-3B) may operate in a siloed manner so that each works largely or exclusively with a dedicated system or subsystem. In one form, they are reporting data back to the topmost tier and then waiting for further instructions once the data has been routed through its mission, mode, interface orchestration and software security. As shown, in certain circumstances, systems or subsystems that operate in cooperation with one another do so through the exchange of data or instructions between the domain controllers within the intermediate tier. The lowermost tier involves the exchange of data between the vehicle control apparatus 100 and the external (that is to say, vehicular) environment. In one form, this exchange takes place through individual system or subsystem controllers (such as the domain controllers 246, 314 (FIGS. 2-3B) that in turn may be dedicated to—or otherwise cooperative with—vehicle electronic devices which may or may not have their own set of interfaces). In another form, one or more of the domain controllers 246, 314 (FIGS. 2-3B) may communicate in a peer-to-peer manner, such as to share data, resources or the like.

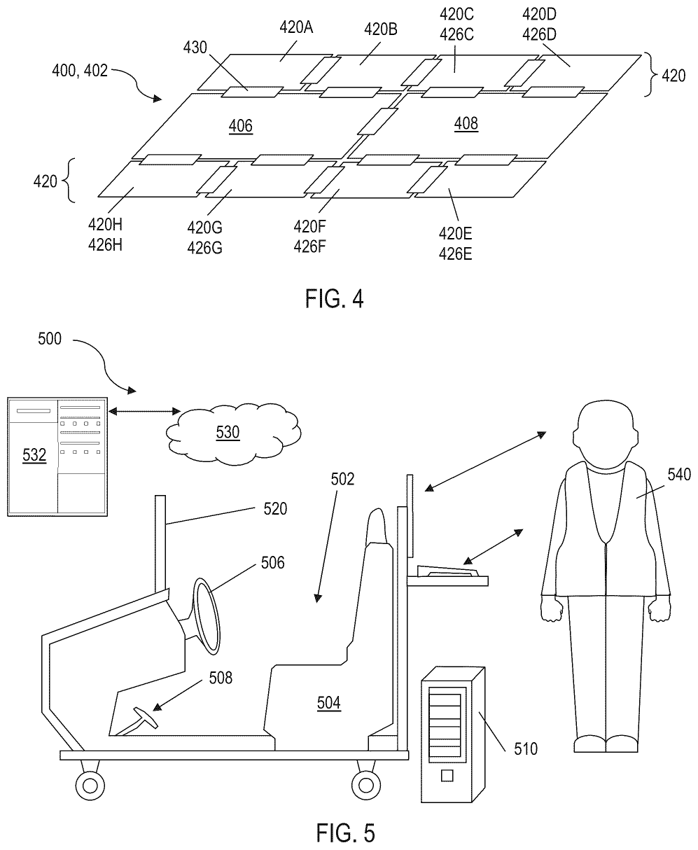

Referring next to FIG. 5, a notional arrangement of a vehicle simulator 500 is shown. The vehicle simulator 500 includes a driver's compartment 502 that includes a seat 504, steering wheel 506 and foot pedals (such as a brake, clutch and accelerator) 508. It will be appreciated that—although not presently shown—other components that are representative of a vehicular cabin may also be included as part of the driver's compartment 502, such as control knobs, touch screens and other switch-based means of driver input. The vehicle simulator 500 also includes one or more computers 510 that are either situated on or placed in signal cooperation with the driver's compartment 502.

An intrinsic capture unit (ICU) 520 is shown in the form of a screen that can act as a two-way mode of conveying information, both to and from a driver that is situated in seat 504. For example, at least a portion of the intrinsic capture unit 520 may include input devices (such as sensors, microphones, image-capturing devices or the like) to acquire information about the driver, such as eye movement, degree of eye openness, head movement, hand movement or the like. Likewise, at least a portion of the intrinsic capture unit 520 may include output devices (such as displays, speakers, haptic motors or other the like) that may provide one or more forms of sensory information to the driver. In one form, these devices may make up part of a larger input/output mechanism. In this manner, the intrinsic capture unit 520 acts as an HMI between a driver, vehicle operator or other user and the as a way to match vehicular system control to the observed behavior of the driver. The acquired data may be processed either locally in an edge-like manner by the computer 510, remotely through the cloud 530 or servers 532, as well as a combination of edge and remote computing. In one form, the observed behavior of the driver may be performed automatically, such as through the anthropomorphic representation of the vehicle control and interconnection system described more fully herein.

Through the use of the vehicle simulator 500 in general and the intrinsic capture unit 520 in particular in conjunction with the vehicle control and interconnection system, a human factors-based approach may be implemented to receive and respond to a driver's preferences (such as driving position, creature comforts, information layout or the like) and actions (such as braking, accelerating, steering, signaling, voice-based interaction, hand gestures, eye monitoring or the like) in response to simulated driving conditions. In this way, naturally gathered data may be used by the vehicle control and interconnection system to provide optimized intelligence.

The vehicle simulator 500 (or, in an alternate form, the cloud 530 or server 532 or other backhaul to which the vehicle simulator 500 is in communication with) further includes a database of known features of the particular vehicle that is being contemplated by the driver for purchase or customization. The final determination of the best match between a user's references and actions relative to a particular vehicle may be performed entirely in an automated fashion (such as through a machine learning implementation of the vehicle control and interconnection system or a related enablement of automated or semi-automated optimized intelligence) or with a certain amount of human-in-the-loop (HITL), such as in an OEM- or dealer-based care center (where a human factors specialist or other knowledgeable individual inspects the intrinsic capture unit 520 data for mission and mode segment fits.

In this way, the vehicle simulator 500 is able to combine each driver's unique style and requirements with the features of the particular vehicle to promote a more intuitive car-buying experience. From there, the analyzed optimum may be conveyed back to the user, such as through a customer mission and mode transcriber that may be subsequently installed in the vehicle control and interconnection system 202, 302, 402 (FIG. 4). In one form, in-service periodic use data may be collected to serve as the basis for further customer adjustment and upgrades, as well as (in the case of machine learning-based analysis) part of additional model training and inference. As can be seen, in one form, the vehicle simulator 500 comprises a standalone unit generally and a portable unit more particularly. In such configurations, the vehicle simulator 500 may in one form supplement the traditional care center and in another supplant it entirely. In another form, where the vehicle simulator 500 is working in concert with cloud 530, servers 532 or other backhaul as part of a larger network-based system, such network may also work with or take the place of traditional care centers.

As such, the ICU 520 presents desired features and services that can be matched to the observed behavior, blending artificial intelligence and human technical translation to clarify critical usability factors and key commands in order to add real human intelligence transparently to a user, either in person or remotely to the vehicle control and interconnection system 202, 302, 402. Moreover, a process using the approach discussed herein accommodates the customers' personal requirements conducted at a convenient location, such as a storefront, a mobile trailer brought to a specified location, a place of business or some other personal location selected by the customer. In one form, all collected data is sent interactively to a care center that uses intelligent software and machine learning programs to craft the final vehicular system for the customer.

In one form, this is ability to combine both preferences and actions is referred to herein as naturally gathered optimized intelligence (which in one form may utilize the various machine learning models discussed herein, such as ones based on neural network approaches) as a way to provide a driver assisted personal touch to the way the vehicle and driver interact.

For example, a number of selected missions such as those that are kept in a database associated with the mission die 420A (FIG. 4) may accommodate numerous modes that are present in the mode die 420B (FIG. 4), particularly even though such modes are dynamic in nature may change over the course of the mission. This in turn necessitates that the vehicle simulator 500 needs to remain constantly in communication with the driver. Thus, the vehicle control and interconnection system 402 (FIG. 4) may be configured as a neural network or other machine learning model that learns vehicle specific optimizations over time. This in turn over time, allows one or more set points passed down by the supervisory processor 220, 304 (FIGS. 2-3B) to be altered, based upon data collected by sensors 242 (FIG. 2) on the vehicle 10 (FIGS. 1A-B) and based upon feedback provided by the mode function controller 240, 420 (FIGS. 2 and 4). As such, the neural network learns (over time) vehicle specific optimizations that alter set points passed down by the supervisory processor 220, 304 (FIGS. 2-3B), based upon data collected by sensors on the vehicle and based upon feedback provided by the mode function controller.

In one form, the vehicle simulator 500 may be used in various pre-purchase or pre-use ways in order to customize a user interface based on driver (or other user) preferences. In this way, when an actual user interface is implemented in an actual vehicle that has operational features that have been modeled by the vehicle simulator 500, it matches that which was created by the vehicle simulator 50 for that particular user.

Although not shown, in one aspect, the vehicle control and interconnection system 202, 302, 402 is used in conjunction with machine learning in order to make data-informed decisions, including predictive decisions. For example, during a pre-purchase phase where the vehicle simulator 500 is being used, a machine learning model may be embodied in one or more of the computers 520, cloud 530 or server 532. In situations where some or all of the model is being implemented locally within the vehicle simulator environment (such as through the computer 510) using data acquired by the vehicle simulator 500, the configuration forms an edge computing environment.

Regardless of where the model is being built (such as through training or the like) and operated, it may be used to better match both a particular vehicle as well as its optimized system or subsystem settings based on information gleaned from the prospective buyer through the intrinsic capture unit 520 as well as other parts of the vehicle simulator 500. Likewise, during the operational (or use) phase of the vehicle, data collected about the driver and the response of vehicle may be used to predict changes in certain system or subsystem settings, as well as generate predictive analytics for matters related to maintenance, imminent or other safety hazards, changes in driver behavior or the like.

In one form, the vehicle control apparatus (either directly or through one or more sensors or related intermediate devices, including those that are connected to or formed as part of one or more of the aforementioned vehicular systems) may form the basis of a supervised machine learning model. In such form, collected data along with statistical or related algorithms may be trained in order to arrive at a fully functional inference (or use) engine. As will be understood, such data acquisition may take place in one or both of an actual vehicular environment (such as the vehicle 10 of FIGS. 1A and 1B) and a simulated vehicular environment such as the vehicle simulator 500.

For example, a machine learning workflow may be used to understand how the model is created for use in or by the operation of the vehicle control apparatus in order to provide visualization and related actionable insights for a driver, system developer or the like. In one form, the use of the vehicle control and interconnection system may be used to automatically extract an optimized subsystem, system or vehicular performance. Moreover, in one form, the vehicle simulator 500—cither alone or in conjunction the vehicle control and interconnection system—extracts relevant user-specific preferences that in one form may be implemented through the machine learning model or related mode of analysis. In this later form, the vehicle simulator 500 may function as an automated or semi-automated data representative.

In one form, raw signal data acquired by the one or more sensors that are present on the vehicle or the vehicle simulator 500 may go through various processing (for example, windowing and filtering), feature engineering (that is to say, to put it into suitable form for one or more machine learning algorithms) and optional computation of summary statistics (for example, to achieve a measure of data normalization) such that extracted data (whether as labeled training data in the case of a supervised model or as actual unlabeled inference data in the case of an unsupervised model) may be subjected to an inference engine in order to present actionable insights in visual form (such as through one or more of the aforementioned HMIs) to an interested party, such as the wearer 540, commander, administrator or the like. As will be discussed in more detail as follows, the choice of machine learning algorithm with which is used in the inference engine that is the embodiment of the machine learning workflow may be based on numerous factors, such as the complexity or sparsity of the data set, computational resources (which in turn may impact the use of edge versus remote data processing infrastructure), time-criticality or the like.

In one form, the vehicle control and interconnection system 202, 302, 402 provides a driver, passenger, system designer or other user context-awareness. In this way, the data may be normalized for each user prior to analysis or execution of the chosen artificial intelligence algorithms and the resulting trained machine learning model. This in turn allows the algorithms and model to be generalizable and valid across a larger group of similarly situated individuals. This context-awareness is enabled by the ability of the vehicle control and interconnection system 202, 302, 402 to extract activity and environmental information and assess the reactions, preferences and related performance state of such user in such context. For example, mission and mode data be combined with sensor or other data to help not only provide context, but also to help formulate suitable subsystem, system or vehicle-level response based on the customization information learned from the vehicle simulator 500, actual operational situations or the like.

Within the present disclosure, program code that is stored in memory to be operated upon by one or more processors will be understood to include the organized collection of instructions and computer data that make up particular application software and system software the latter of which may include operating system software and basic input/output that relates to the operation of the associated computing device, whether embodied on the vehicle control and interconnection system 202, 302, 402 or elsewhere in, on or otherwise cooperative with the vehicle or vehicle simulator 500. This and other software (such as system software or application-specific software) provides programmed instructions that may be implemented on such processors to allow interaction between the vehicle control and interconnection system 202, 302, 402 and the corresponding subsystem, system or other vehicular component, controller or the like in order to perform one or more of the data acquisition, processing, communicating, analysis and related functions—as well as device control—disclosed herein.

For example, source code may be converted into executable form as machine code for use by the processor; such machine code is predefined to perform a specific task in that they are taken from a machine language instruction set known as the native instruction set that may be part of a shared library or related non-volatile memory that is specific to the implementation of the processor and its particular Instruction Set Architecture (ISA). As such, software instructions such as those embodied in the corresponding portion of the machine code configure the processor to provide the program structure and associated functionality as discussed herein.

For instance, a program structure in the form of a flow diagram of how the vehicle control and interconnection system 202, 302, 402 may be used to develop the machine learning model through an ordered sequence as part of the aforementioned machine learning workflow that as noted may include one or more of raw data acquisition, data cleansing or related preprocessing, feature extraction of derived values which may include placing the data into a feature vector or related form, and which may involve some form of data mining or related exploratory data analysis, training for application of the one or more iterative machine learning algorithms to fit or create the model and finally a model use or inference for operation of the trained machine learning workflow on some or all of the acquired data from the vehicle or vehicle simulator 500 as a way to draw inferences from such acquired data. In one form, this ordered sequence may be used to provide predictive analytics to assist in the diagnosis or prognosis by the driver, passenger, system developer or other interested personnel. In one form, the first three steps may be considered to form the core of data management, while the last two steps and the resulting machine learning model lead to learning, inference or related analytics to acquire intelligence from the data set. Significantly, the vehicle control and interconnection system 202, 302, 402 will adapt to changing circumstances, including those associated with driver preferences or the like. Thus, the longer a person uses the vehicle control and interconnection system 202, 302, 402, the more accurate its artificial intelligence capability becomes.

In one form, training may take place through known baseline or acquired data. For example, such data may be made of one or both of baseline data (of either a particular driver or of a demographic group that may be representative of the particular driver) as well as that can be taken from the previously-discussed and presently-acquired data and stored in memory in an unstructured, flat file format such that during the cleansing or related preprocessing associated with the preprocessing, improvements in data uniformity may be realized. In one form, grouping the data can be through an unsupervised clustering model; such an approach may be particularly good at segmenting the data into several different groups. In one form, the baseline data may be annotated for use in training-based activity, behavior or related parametric information that can be compared to the presently-acquired data. In a similar way, such data may be subjected to one or more of validation and testing. It will be appreciated that any or all forms of data may be expressed as a vector, array or multidimensional array (that is to say, tensor) in order to be in appropriate feature vector form for subsequent use of the independent data in the feature extraction.

As part of the cleansing or preprocessing, the acquired data may be tagged or identified, including through the use of spatio-temporal identifiers. Data acquisition libraries, such as those available from Python may be used to provide sensor-based data acquisition support for such tagging and identification; such support may include other forms of data preprocessing, including class-labeling, noise filtering and related cleansing or scrubbing, as well as data balancing, all as a way to transform the data into a form that may be used by the subsequent feature extraction, algorithm selection, training and eventual predictive analytics model usage. In one example, the acquired data that has been operated upon by some or all of these libraries may be subjected to receiver operating characteristic (ROC) analysis as a way to quantify the performance of a machine learning classification algorithm. In one form, such an analysis may be in the form of a curve to provide visual comparison between various classification models where the area under the ROC curve (AUC) provides a measure of accuracy of a particular machine learning model. This model evaluation, which takes place once a model is tested and evaluated, may also be based on other criteria such as mean squared error, accuracy, sensitivity, specificity or the like. In this way, the activity classification algorithm can use known diagnostic performance metrics such as ROC and area AUC values, positive and negative predictive value, sensitivity, specificity or the like to allow a comparison against expert-based expert diagnoses or prognoses.

In one form, filters may be applied to control data sampling rates or the like. In one form, statistical-based feature extraction may be used on the presently-acquired data. In one form, the feature extraction may be accomplished through adders, multipliers, impulse filters, band-pass filters or related mathematical operation circuitry contained within the processor or elsewhere. For example, peak analysis may be used to find important frequency content, such as through Fast Fourier Transform or the like.

While it is understood that different kinds of data may involve different methods for cleansing or preprocessing, there are some methods that tend to be employed for almost all forms of data. As part of this second step of the machine learning workflow, the data that is being acquired by the vehicle control and interconnection system 202, 302, 402 may be filtered, amplified and converted, either at the edge or at a centralized location such as the cloud 530 an example of which is depicted in FIG. 5. For example, the acquired data may go through a normalization process in situations where features (that is, the columns within a matrix or array of data) have different ranges. With normalization, the numeric values of the data are adjusted to a common scale while substantially preserving differences in the ranges of values in order to avoid gradient upsets (and a consequent failure to converge) during subsequent optimization during training. In addition, the presently-acquired data is typically transformed into vectors or related meaningful numeric representation, as previously discussed. Thus, for every row of a particular type of data, it can be converted into suitable integer values as a way to populate an input matrix. Furthermore, the data may be sparse and therefore have missing values, in which either zero-value or interpolated mean value placeholders may be inserted into the respective column of the matrix.

In one form, such cleansing or preprocessing need not be a part of a machine-learning-based approach, and instead may be used for other forms of analysis where improvements in data uniformity and manageability are needed. Regardless of the form used, the architecture of the vehicle control and interconnection system 202, 302, 402 is such that it not only improves the operation and efficiency of the reception and transmission of various forms of data, but also of the data gathering itself in that by acting as a single point for data gathering, the aggregation of the data gathering and dissemination need not be dispersed over larger portions of a network. This in turn helps promote consistency of the data, as well as more real-time data collection and response attributes. Moreover, by providing a singular, unitary platform, the vehicle control and interconnection system 202, 302, 402 is able to provide for a relatively unobtrusive user experience, whether as a prospective vehicle purchaser or as a subsystem, system or vehicle designer.

This second step of the machine learning workflow is also useful in making subsequent analytic inferences from the data more tractable. For example, redundancy and size of an initial set of raw features taken from the baseline or presently acquired data can make such data difficult to manage. In particular, the acquired data is often diverse and complex, even for the same driver or related user during different operational scenarios. The amount of information associated with both the baseline and acquired data is potentially voluminous, and often of a heterogeneous nature. In addition to ensuring that the data is uniform as a prerequisite for rendering it useful for its intended purpose of extracting machine learning insights, another prerequisite may be to reduce its dimensionality. Such dimensionality reduction may be seen as a portion of the second step of the machine learning workflow and its five-step ordered sequence. In one form, the data interpretation may be performed by one or more portions of machine code that are operated upon by the various processors such that output of the analysis is provided (such as through the aforementioned HMIs) to a user. In one form, the results of the analysis that are associated with such output may be stored in memory, as well as provided in transient, real-time to a display, audio device, GUI 60 or the like all of which may form a part of the HMI or related user interface, including the intrinsic capture unit 520.

In one form, the process of converting the raw data into a form suitable for use in a machine learning workflow and subsequent model may form part of an activity known as extraction, transformation and loading (ETL) that may make up part of the previously discussed second and third steps of such workflow. Within the present context, ETL may be used to decompose multi-sensor data into a suitable feature vector within a given feature space that can then be correlated through subsequent fitting and evaluation of the fourth and fifth steps of the machine learning workflow in order to produce one or more model-based performance metric results for certain types of predictive analytic activities, such as those associated with lung function determination or prediction. By way of example, a feature space in two dimensions may be represented through the two axes of a common x-y graph, while additional representations along a third axis (for example, the z-axis) may be made to correspond to outputs, such as those of one of more hidden layers in a neural network in order to define a feature space in three (or more) dimensions in a manner analogous to a tensor. Within the present disclosure, the term “converting” and its variants are understood to include all steps necessary to achieve ETL functionality, including cleansing of the data or reducing its dimensionality the latter of which may be in the form of feature selection.

The models employed by the vehicle control and interconnection system 202, 302, 402—which may include machine code that can be written in or converted from one of several programming languages such as Kotlin, Python, Java, R or the like—as well as employing their corresponding ML libraries or toolkits, such as MATLAB, NumPy, Weka, kernlab, SciPy, LIBSVM, SAS, SVMlight, Scikit-Learn, JKernalMachines, Shogun or others—engage in iterative approaches to update the decision-making process as a way to learn from the various forms of data being acquired by the vehicle control apparatus 100. For example, a machine learning library such as Scikit-learn may be used with the Python programming language to provide various classification, regression and clustering algorithms including support vector machine, random forests or others. In addition, it operates in conjunction with Python numerical and scientific libraries NumPy and SciPy.

Moreover, APIs (such as TensorFlow, H₂O, Spark MLlib or the like) may be used to help determine the best machine learning workflow to use, while some of the previously mentioned libraries may include unified APIs to facilitate case of use of a particular model. In one form, an open-source core library such as NumPy is used for performing fast linear algebra and related scientific computing within the Python programming language. NumPy provides support operations for multidimensional array and matrix (but not on scalar quantities) data structures, along with a large collection of high-level mathematical functions to operate on these arrays. For example, the linear equations that represent linear algebra are presented in the form of matrices and vectors that may be memory-mapped as data structures for computing complex matrix multiplication relatively easily. The hybrid SoC-SiP structure depicted in FIGS. 2-4 may further be used to allow at least some portions of the machine learning workflow to take place in a localized, edge-like manner rather than rely largely or solely on servers 532, the cloud 530 or other remote computing infrastructure.

Because the data that is being acquired by the vehicle control and interconnection system 202, 302, 402 is multidimensional and takes place over time, multidimensional data structures known as Pandas (that is to say, PANel DAta Sets) may be used for the initial data preprocessing. Such data may be input into vectors such as Pandas data structures (also referred to as dataframes) or NumPy arrays such that they can later be broken up into training data sets, validation data sets and test data sets for machine learning use.

Moreover, it is possible through feature extraction-based parameter-reduction techniques such as gradient descent, backward propagation or the like to prune a network (such as a deep learning neural network) and improve the mapping between data input and output to achieve minimized cost functions associated with classifying the corresponding condition, operation, response or other activity being predicted. Thus, at least in supervised versions of the machine learning workflow, feature extraction takes advantage of knowledge already known to help provide those predictive features most likely of use for interested personnel. As noted elsewhere, data acquired through the vehicle simulator 500 may be one way to acquire threshold data for use in one or more parts of the machine learning workflow. Such reduction techniques, as well as those associated with convolutional weighted kernels, filters, channels or the like, are additionally helpful in their ability to reduce the processor and memory requirements associated with deep learning algorithms and models, thereby allowing them to operate with significant reductions in computational and storage power, including those where the supervisor and processor supervisor 406 of the hybrid SoC-SiP structure depicted in FIGS. 2-4 is being used for some or all of the machine learning workflow.

Within the machine learning context, various analogies and terms may be useful in understanding how the data that is being acquired by the vehicle control and interconnection system 202, 302, 402 may be correlated to information pertaining to the operation of one or more of the subsystems, systems or vehicles discussed herein, as well as those of the driver or other user whose behavior is being sought to be matched up with a particular vehicle and its flexible or customizable operational attributes. For example, terms related to the data being acquired, analyzed and reported include “instance”, “label”, “feature” and “feature vector”. An instance is an example or observation of the data being collected, and may be further defined with an attribute (or input attribute) that is a specific numerical value of that particular instance, while a label is the output, target or answer that the machine learning algorithm is attempting to solve, the feature is a numerical value that corresponds to an input or input variable in the form of the sensed parameters, whereas a feature vector is a multidimensional representation (that is to say, vector, array or tensor) of the various features that are used to represent the object, phenomenon or thing that is being measured by the vehicle control and interconnection system 202, 302, 402.

Visually, the instance, label and feature can populate a data table (or spreadsheet) such as the previously-mentioned x-y graph or x-y-z graph where the instances may be listed as numerous rows within a single label column, whereas the features populate various labeled columns for each row. To think of it colloquially, the use of a machine learning model to solve a classification, regression or other problem can be analogized to preparing a meal, where (a) the data being acquired by the vehicle control and interconnection system 202, 302, 402 corresponds to the ingredients to be used, (b) the mathematical code that is the algorithm is a sequence of actions that may be analogized to the tools, equipment, appliances or the like that operates on the ingredients, (c) the machine learning model is the recipe that is used in conjunction with the algorithmic tools to provide a framework for repeatability and (d) the label is the desired output in the form of the finished dish.

Thus, the machine learning model may be understood as the recipe that is formed by using the correct number and quantity of ingredients from the data that have been subjected to trial-and-error training through the use of the tools that make up the algorithm. As such, the machine learning model is a mathematical description of how to convert input data into a labeled output; a new model may be generated with the same algorithm with different data, or a different model may be generated from the same data with a different algorithm. Thus, within the context of machine learning, the algorithms discussed herein are constructed to learn from and make predictions in a data-driven manner based on the data being acquired by the vehicle control and interconnection system 202, 302, 402, and from these algorithms, the machine learning model may be built for subsequent use in identifying various metrics related to the driver, operator or other user that is using vehicle control and interconnection system 202, 302, 402. In this way, the machine learning model is the resulting output once a machine learning algorithm has been trained by the acquired data.

In one form, the feature vectors (which may occupy a corresponding feature space) are subjected to a scalar multiplication process in order to construct a weighted predictor function. Moreover, feature construction may be achieved by adding features to those feature vectors that have been previously generated, where operators used to perform such construction may include arithmetic operators (specifically, addition, subtraction, multiplication and division), equality conditions (specifically, equal or not equal) and array operators (specifically, maximums, minimums and averages) among others. In one form, the analytics associated with these feature vectors may be performed in order to ascertain classification-based results (for example, whether the sensed parameter or attribute is less than, equal to or greater than a threshold that may itself be based on a known relative baseline, absolute baseline or other measure of interest), or to perform a regression in order to determine whether the sensed parameter or its attribute can be correlated to the likelihood of an event outcome. Within the present context, a feature vector could be a summary of such data such that the ensuing observation of missions, modes and driver response may lead to an enhanced understanding of how to use the vehicle control and interconnection system 202, 302, 402 in order to customize the vehicle 10 (FIG. 1) as much as possible to the user's needs.

In one form, some or all of the program structure that defines the last three steps (that is, feature extraction, algorithmic training and use of the subsequent model to generate useful analytical output or prediction) of the multistep machine learning workflow may be embodied in the machine code that is discussed elsewhere herein. In this way, particular forms of data extraction may be performed through the manipulation of this data through the cooperation of the processors and the machine code, as can one or more of the machine learning algorithms discussed herein for use with the training and subsequent machine learning workflow analysis. As such, the use of machine learning

As can be seen from the foregoing, for the machine learning portion of the analysis, certain canonical approaches may be used as part of the machine learning workflow in order to train the resulting model. While not being bound by theory, and further in recognizing that many machine learning algorithms (including, but not limited to, k-nearest neighbors (kNN), neural networks (including convolutional neural networks and its deep learning variants), hidden Markov approaches, naïve Bayes, decision treats (such as classification and regression trees (CART) or C4.5), ensemble methods (including boosting, bootstrap aggregating (bagging) and random forest), support vector machines, other Bayesian approaches, regression-based approaches, clustering approaches (such as K-means clustering), dimensionality reduction approaches (such as principal component analysis (PCA) or linear discriminant analysis (LDA), Markowitz-based approaches, recurrent approaches which may be further grouped into, among others, perceptrons, sequential/recurrent, long short-term memory (LSTM), Hopfield, Boltzmann machines, deep belief networks, auto-encoders or the like), reinforcement learning, cross-validation and stochastic gradient descent, as well as combinations thereof) are available for use, the author of the present disclosure has recognized that in situations where the acquired data is sparse or intermittent, certain machine learning algorithms generally perform better than others. For example, support vector machines and random forest have generally performed well with sparse datasets. As such, the use of a particular algorithm (or algorithms) in pursuit of a preferred machine learning model may be dictated by the quality and quantity of the data gathered, whether during simulated conditions such as the pre-purchase conditions associated with the vehicle simulator 500 or in real-time operational conditions within an actual vehicle such as vehicle 10 (FIG. 1).

Likewise, the knowledge gained through a machine learning model may be used by developers (including third-party ones) to provide low-code/no-code functionality. In this way, improvements in achieving a desirable degree of control and data flow in a timely manner may be realized. For example, the relationship between the mission, the mode, any interface orchestration and software security may be established for the contributed supervisor and the distributed control of the processor supervisor 406 (FIG. 4) (such as to allow for expedited interaction with the various peripheral dies 408 (FIG. 4) that make up the domain controllers). This in turn promotes the exchange of data (including the mission and mode, among others) between the domain controllers and the various subsystems, systems and other portions of the vehicle and its external environment.

In situations where edge computing along with machine learning is being deployed by the vehicle control and interconnection system 202, 302, 402 or other parts of the systems disclosed herein (with or without interaction with the vehicle control and interconnection system), its use and development of databases (such as customer preferences, market knowledge, environmental conditions or related baseline information or the like), coupled with highly localized computing resources promotes real-time, flexible solutions to customer-specific needs. For example, autonomous or semi-autonomous driving attributes (such as dedicated lanes, tandem trucking, geofenced areas or the like) may be embodied as one or more missions or modes through their respective controllers such as depicted in FIGS. 2-4 to enable edge-based control. Thus, the information exchanged by cooperation of the vehicle control and interconnection system 202, 302, 402 with the various vehicle subsystems 250, 316 (FIGS. 2-3B), along with real-time on-vehicle processing enables various modes of partially or completely autonomous operation of vehicle 10 (FIG. 1).

Regardless of whether machine learning is or is not used, by equating a user-optimized setting to individual driver preferences, a more personalized subsystem system or vehicle-level design based on driving styles of such user is enabled. As such, the description of the present disclosure has been presented for purposes of illustration and description, but is not intended to be exhaustive or limited to form disclosed. Many modifications and variations will be apparent to those of ordinary skill in the art without departing from the scope and spirit of the disclosure. For example, some or all of the user input received during a pre-purchase customization stage (also referred to as a building stage) for vehicle 10 (FIG. 1) may also be used during actual operation of the vehicle 10 in order to help performance of the overall vehicle 10 (FIG. 1) or one or more of its subsystems 250, 316 (FIGS. 2-3B).

As can be seen from the entirety of this disclosure, the flexible architecture provided by the vehicle control and interconnection system 202, 302, 402, the tile-based computing architecture of the vehicle control and interconnection system 202, 302, 402 with its reconfigurable device space 214 (FIG. 2) and (among other things) its centributed supervisor 406 and processor supervisor 408 (FIG. 4) and system interfaces 420 allows for communication with—as well as hierarchical control over—one or more of the vehicle subsystems 250, 316 (FIGS. 2-3B). In this way, a hybrid form of both centralized and distributed control over various vehicular systems 250, 316 (FIGS. 2-3B) may be utilized. The use of the reconfigurable device space 214 (FIG. 2) and the associated customization of the underlying SoC or PSoC further allows rapid training of machine learning (in particular, neural network) models that in turn can perform on-vehicle, real-time computations for various use scenarios. Also as depicted herein, optimized naturally-gathered intelligence of driver-specific needs by the vehicle simulator 500 (which includes—among other components—the intrinsic capture unit 520), often in conjunction with the vehicle control and interconnection system or related driver-preference mechanism, allows the vehicle control and interconnection system 202, 302, 402 to function as a manufacturing-like process in order to help customize the vehicle to individualized customer needs. For example, the vehicle control and interconnection system is used to set or suggest a final personal tuning or configuration of a driver interface through empirical or ad hoc observation of data that is acquired through the intrinsic capture unit 520.

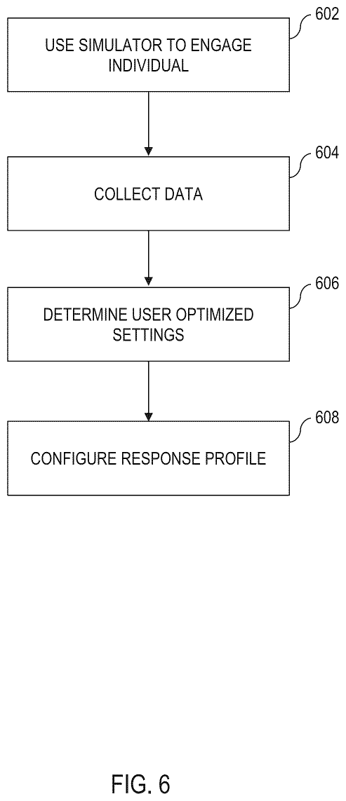

As an illustrative example, reference is drawn to FIG. 6, which illustrates a method 600, of customizing a vehicle control and interconnection system to an individual. The method 600 can be utilized with any of the features described herein, including the vehicle simulator with the intrinsic capture unit (FIG. 5).

The method 600 comprises using at 602 a vehicle simulator to engage the individual to perform at least one vehicular operation in the vehicle simulator. Here, the vehicle simulator is configured to be representative of a particular vehicle being contemplated for purchase by the individual, such as the vehicle simulator (FIG. 5). In this regard, the vehicle simulator can comprise an intrinsic capture unit analogous to that described with reference to FIG. 5.

The method 600 also comprises coordinating at 604, the vehicle simulator with a plurality of simulated vehicle electronic devices to cause the vehicle simulator to collect data corresponding to observed behavior of the individual. The collected data can comprise, for example, at least one of sensory data of the individual through the intrinsic capture unit, or at least one operational parameter of at least one of the plurality of simulated vehicle electronic devices in response to the at least one vehicular operation that is performed by the individual.

The method 600 yet further comprises determining, at 606, based on the collected data, a user-optimized setting for at least one of the plurality of simulated vehicle electronic devices.

The method 600 still further comprises configuring, at 608, a response profile for the at least one of the plurality of simulated vehicle electronic devices based on the user-optimized setting. In this manner, the response profile is usable to program a customized vehicle user interface of a vehicle control and interconnection system associated with a vehicle.

In some implementations, the plurality of simulated vehicle electronic devices correspond to a plurality of vehicle domain controllers of a representative vehicle subsystem within an actual vehicle that corresponds to the particular vehicle being contemplated for purchase by the particular individual. In this manner, as described more fully herein, the vehicle control and interconnection system can optionally comprise at least a supervisory processor, a real-time operating system, at least one field programmable gate array, at least one peripheral processor and a reconfigurable space that cooperate with one another to generate the customized vehicle user interface.

Here, the vehicle control and interconnection system can be integrated into a system in a package (SiP) format. Moreover, the plurality of vehicle domain controllers of a representative vehicle subsystem can comprise at least one of a steering wheel controller, an accelerator controller, a brake controller, a turn signal indicator controller, an infotainment system controller, a climate system controller, a security system controller, a powertrain system controller, a drivetrain system controller and combinations thereof.

In some implementations, the method 600 further comprises configuring the customized vehicle user interface to display content based on at least one representative vehicle subsystem of the particular vehicle being contemplated for purchase by the particular individual.

In some implementations of the method 600, the vehicle simulator comprises a machine learning model that has been trained by at least one algorithm that comprises a machine code to cleanse at least a portion of at least one of the collected data, a machine code to extract at least one feature from the cleansed data, and a machine code to execute the at least one machine learning algorithm using the at least one feature, the at least one feature corresponding to at least one of each response profile.

In some implementations, the method 600 further comprises electronically receiving answers that correspond to at least one question presented to the particular individual, and creating an electronic user profile of the particular individual based on a combination of the data collected through the intrinsic capture unit and the received answers.

In some implementations, the method 600 further comprises utilizing at least one imaging device to capture data having a field of view configured to include the particular individual. For instance, the imaging device can be used to capture data corresponding to the particular individual through the intrinsic capture unit, such as at least one of height data, weight data and seating position data.

In some implementations of the method 600, at least one vehicular operation that is performed by the particular individual using the vehicle simulator comprises at least one simulated driving maneuver.

In some implementations of the method 600, the vehicle simulator is packaged in a portable form factor.

In some implementations of the method 600, the vehicle simulator comprises an application programming interface (API) that is placed in signal communication with the vehicle subsystem through at least one of the controller, a server, a standalone computer, a gateway and the cloud.

As a few other miscellaneous considerations, in some implementations of the method 600, the sensory data of the particular individual comprises at least one of voice recognition, hand gestures and eye movement. In some implementations of the method 600, the at least one vehicular operation that is performed by the particular individual comprises at least one simulated driving maneuver. In some implementations, the method 600 further comprises analyzing the observed behavior of the driver.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components or groups thereof.

Within the present disclosure, one or more of the following claims may utilize the term “wherein” as a transitional phrase. For the purposes of defining features discussed in the present disclosure, this term is introduced in the claims as an open-ended transitional phrase that is used to introduce a recitation of a series of characteristics of the structure and should be interpreted in like manner as the more commonly used open-ended preamble term “comprising” and its variants that do not preclude the possibility of additional acts or structures.

Within the present disclosure, terms such as “preferably”, “generally” and “typically” are not utilized to limit the scope of the claims or to imply that certain features are critical, essential, or even important to the disclosed structures or functions. Rather, these terms are merely intended to highlight alternative or additional features that may or may not be utilized in a particular embodiment of the disclosed subject matter. Likewise, it is noted that the terms “substantially” and “approximately” and their variants are utilized to represent the inherent degree of uncertainty that may be attributed to any quantitative comparison, value, measurement or other representation. As such, use of these terms represents the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and Care definite or indefinite articles that are the referents of the prepositional phrase) means A alone, B alone, C alone, A and B together, A and C together, B and C together, or A, B and C together.

Within the present disclosure, the following claims are not intended to be interpreted based on 35 USC 112(f) unless and until such claim limitations expressly use the phrase “means for” or “steps for” followed by a statement of function void of further structure. Moreover, the corresponding structures, materials, acts and equivalents of all means or step plus function elements in the claims below are intended to include any structure, material or act for performing the function in combination with other claimed elements as specifically claimed.

Within the present disclosure, the singular forms “a,” “an” and “the” include plural references unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6 to 9, the numbers 7 and 8 are contemplated in addition to 6 and 9, and for the range 6.0 to 7.0, the number 6.0, 6.1, 6.2, 6.3, 6.4, 6.5, 6.6, 6.7, 6.8, 6.9 and 7.0 are explicitly contemplated.

The present description is for the purpose of illustration and is not intended to be exhaustive or limited. Many modifications and variations will be apparent to those of ordinary skill in the art without departing from the scope and spirit of the present disclosure. Aspects of the present disclosure were chosen and described in order to best explain the principles and practical applications, and to enable others of ordinary skill in the art to understand the subject matter contained herein for various embodiments with various modifications as are suited to the particular use contemplated.

Unless otherwise defined, all technical and scientific terms used herein that relate to materials and their processing have the same meaning as commonly understood by one of ordinary skill in the art. In case of conflict, the present document, including definitions, will control.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Having thus described the invention of the present application in detail and by reference to embodiments thereof, it will be apparent that modifications and variations are possible without departing from the scope of the invention defined in the appended claims.

What is claimed is:

1. A vehicle control and interconnection system that electrically and communicably couples to native vehicle electronics, the vehicle control and interconnection system comprising:
system memory;
a supervisory processor incorporated into a system in a package (SiP) format, which is communicably coupled to the system memory;
a mission function controller communicably coupled to the supervisory processor;
a mode function controller communicably coupled to the supervisory processor;
a peripheral controller that communicates, responsive to commands initiated by the supervisory processor, via an interface, control messages initiated by the peripheral controller to a corresponding vehicle electronic device; and
kernel memory that stores code to support at least:
the supervisory processor; and
the peripheral controller;
wherein:
the mission function controller and the mode function controller cooperate to receive control information from the supervisory processor and pass modified control information to the peripheral controller.

2. The vehicle control and interconnection system of claim 1, wherein the mission function controller interacts with:
an interface orchestration that provides a graphical user interface that enables a vehicle operator to interact with the mission function controller to select the customized operation of the vehicle; and
a software security process that verifies and validates the operator selected customized operation and corresponding control information to ensure proper operation of the vehicle according to predefined security rules.

3. The vehicle control and interconnection system of claim 1, wherein the mission function controller and the mode function controller are virtualized processors controlled by a hypervisor that certifies the mission function controller and the mode function controller as verified compatible with the vehicle electronic devices.

4. The vehicle control and interconnection system of claim 1, wherein the supervisory processor prioritizes a prime set of functions such that the mission function controller carries out commands from the supervisory processor to a relevant one or more of the prime set of functions, the prime set of functions comprising:
an energy function controller that controls a vehicle energy domain subsystem of the vehicle;
a propulsion function controller that controls a vehicle propulsion domain subsystem of the vehicle;
a dynamics function controller that controls a vehicle dynamics domain subsystem of the vehicle;
a personalization function controller that controls a vehicle personalization domain subsystem of the vehicle;
a security function controller that controls a vehicle security domain subsystem of the vehicle; and
a communication function controller that controls a vehicle communication domain subsystem of the vehicle.

5. The vehicle control and interconnection system of claim 4, wherein the supervisory processor prioritizes, after the prime set of functions, an auxiliary set of functions, the auxiliary set comprising at least one of a telematic function and a video capture system.

6. The vehicle control and interconnection system of claim 1, wherein the SiP further comprises working memory that stores authorized and validated vehicle software applications that carry out customized vehicle applications.

7. The vehicle control and interconnection system of claim 1, wherein the SiP further comprises a neural network that learns over time, vehicle specific optimizations that alter set points passed down by the supervisory processor, based upon data collected by sensors on the vehicle and based upon feedback provided by the mode function controller.

8. The vehicle control and interconnection system of claim 1, wherein the SiP further comprises a field programmable gate array configured such that hardware processing functionality can be programmed and modified to add new hardware processing capability.

9. The vehicle control and interconnection system of claim 1, wherein:
the SiP is configured such that control commands can flow down from the supervisory processor to the peripheral controller;
no commands can flow from the peripheral controller up to the supervisory processor; and
data collected through the peripheral controller can flow up to the supervisory processor.

10. The vehicle control and interconnection system of claim 1, wherein the supervisory processor issues commands based upon data collected by at least one vehicle sensor, the collected data processed by at least one of the mission function controller or the mode function controller.

11. The vehicle control and interconnection system of claim 10, wherein the collected data is derived from an external source via at least one of a telematics unit or Wi-Fi on the vehicle.

12. A method of customizing a vehicle control and interconnection system to an individual, the method comprising:
using a vehicle simulator to engage the individual to perform at least one vehicular operation in the vehicle simulator, where the vehicle simulator is configured to be representative of a particular vehicle being contemplated for purchase by the individual, the vehicle simulator comprising an intrinsic capture unit;
coordinating the vehicle simulator with a plurality of simulated vehicle electronic devices to cause the vehicle simulator to collect data corresponding to observed behavior of the individual and comprising at least one of:
sensory data of the individual through the intrinsic capture unit;
at least one operational parameter of at least one of the plurality of simulated vehicle electronic devices in response to the at least one vehicular operation that is performed by the individual;
determining, based on the collected data, a user-optimized setting for at least one of the plurality of simulated vehicle electronic devices; and
configuring a response profile for the at least one of the plurality of simulated vehicle electronic devices based on the user-optimized setting, the response profile usable to program a customized vehicle user interface of a vehicle control and interconnection system associated with a vehicle.

13. The method of claim 12, wherein the plurality of simulated vehicle electronic devices correspond to a plurality of vehicle domain controllers of a representative vehicle subsystem within an actual vehicle that corresponds to the particular vehicle being contemplated for purchase by the particular individual.

14. The method of claim 12 further comprising configuring the customized vehicle user interface to display content based on at least one representative vehicle subsystem of the particular vehicle being contemplated for purchase by the particular individual.

15. The method of claim 12, wherein the vehicle simulator comprises a machine learning model that has been trained by at least one algorithm that comprises:
a machine code to cleanse at least a portion of at least one of the collected data;
a machine code to extract at least one feature from the cleansed data; and
a machine code to execute the at least one machine learning algorithm using the at least one feature, the at least one feature corresponding to at least one of each response profile.

16. The method of claim 12 further comprising:
electronically receiving answers that correspond to at least one question presented to the particular individual; and
creating an electronic user profile of the particular individual based on a combination of the data collected through the intrinsic capture unit and the received answers.

17. The method of claim 12 further comprising:
utilizing at least one imaging device to capture data having a field of view configured to include the particular individual.

18. The method of claim 14, wherein at least one vehicular operation that is performed by the particular individual using the vehicle simulator comprises at least one simulated driving maneuver.

19. The method of claim 12, wherein the vehicle simulator is packaged in a portable form factor.

20. A vehicle control and interconnection system configured as a system in a package (SiP), the vehicle control and interconnection system comprising:
a substrate with electrical traces formed therein;
a first system-on-chip (SoC) device situated on the substrate and configured as a kernel comprising:
a supervisory processor that prioritizes a core set of functions;
a mission function controller that provides control information that corresponds to customized vehicle operation;
a mode function controller that provides dynamic modification of the control information based on at least one determined operating condition of the vehicle; and
a peripheral controller cooperative with the supervisory processor to control vehicle electronic devices that are operative to commands by the supervisory processor;
wherein:
the mission function controller and the mode function controller cooperate to receive control information from the supervisory processor and pass modified control information to the peripheral controller;
a second SoC situated on the substrate and configured as a core to be signally cooperative with both the first SoC and substrate through the electrical traces;
a plurality of peripheral dies situated on the substrate, each of the plurality of peripheral dies defining a domain controller that couples the vehicle control and interconnection system to at least one vehicle subsystem; and
an interface that establish signal communication between adjacent peripheral dies and at least one of the first and second SoCs through at least an embedded multi-die interconnect bridge, wherein the vehicle control and interconnection system establishes signal communication with the at least one vehicle subsystem through at least one of the control information of the mission function controller and the modified control information of the mode function controller.
